(19) United States
(12) Patent Application Publication
(10) Pub. No.: US 2009/0136796 A1
(43) Pub. Date: May 28, 2009

(54) FUEL CELL SYSTEM AND METHOD OF ACTIVATING THE FUEL CELL

(76) Inventors: Gennadi FINKELSHTAIN, Shoham (IL); Mark KINKELAAR, Glenmoore, PA (US); Nadav BAR-OR, Tel-Aviv (IL); Ilan SADON, HaOranin (IL); Moti MERON, Hertzella (IL); Yuri KATSMAN, Hadera (IL)

Correspondence Address: GREENBLUM & BERNSTEIN, P.L.C., 1950 ROLAND CLARKE PLACE, RESTON, VA, 20191, US

(21) Appl. No.: 12/342,286

(22) Filed: Dec. 23, 2008

Related U.S. Application Data
(62) Division of application No. 11/819,542, filed on Jun. 28, 2007.
(60) Provisional application No. 60/817,068, filed on Jun. 29, 2006.

(51) Int. Cl. H01M 8/04

(52) U.S. Cl. 429/14

(57) ABSTRACT

Fuel cell system including a fuel cell assembly having an anode and a cathode. A fuel/electrolyte module includes a liquid fuel and/or a liquid electrolyte and/or components of the liquid fuel and/or the liquid electrolyte. A housing arrangement houses the fuel cell assembly and the fuel/electrolyte module. A system is used for transferring at least a part of the contents of the fuel/electrolyte module into the fuel cell assembly. A method is also disclosed of generating electrical power using a power system including at least one fuel cell unit having a fuel cell assembly and a fuel/electrolyte module arranged within a housing arrangement. This Abstract is not intended to define the invention disclosed in the specification, nor intended to limit the scope of the invention in any way.

### CROSS-REFERENCE TO RELATED APPLICATIONS

The present application is a divisional of U.S. application Ser. No. 11/819,542 filed Jun. 28, 2007, the disclosure of which is expressly incorporated by reference herein in its entirety. The present application also claims priority under 35 U.S.C. §119(e) of U.S. provisional Application No. 60/817,068 filed Jun. 29, 2006, the disclosure of which is expressly incorporated by reference herein in its entirety.

### BACKGROUND OF THE INVENTION

1. Field of the Invention

The present invention relates to a direct liquid fuel cell system which is particularly suitable for use with a hydride and/or borohydride based liquid fuel.

The invention is also directed to a fuel cell system with an integrally arranged cartridge or fuel/electrolyte storage system which can activate the fuel cell. The fuel cell can be fueled, e.g., manually or automatically, by pressing portions of the fuel cell system towards one another.

2. Discussion of Background Information

Liquid fuel cells produce electricity by oxidizing a liquid fuel at an anode of the fuel cell and at the same time reducing an oxidant such as, e.g., oxygen at a cathode. The anode and the cathode are in contact through an electrolyte which may be a liquid, a gel, etc. As the fuel cell produces electricity, the liquid fuel and the electrolyte are gradually exhausted of their useful components.

### SUMMARY OF THE INVENTION

The present invention provides fuel cell systems and methods of generating electrical power as recited in the appended claims.

The fuel cell systems of the present invention preferably include one or more of the technologies (fuel cells, fuel compositions, electrodes, electrolytes, cartridges, gas elimination devices, devices for preventing fuel decomposition, etc.) which are disclosed in, e.g., U.S. Pat. Nos. 6,554,877, 6,758,871 and 7,004,207 and pending U.S. patent application Ser. Nos. 10/757,849 (US2005/0155279 A1), 10/758,081 (US2005/0155668 A1), 10/634,806 (US2005/0058882 A1), 10/758,080 (US2005/0158609 A1), 10/803,900 (US2005/0206342 A1), 10/824,443 (US2005/0233190 A1), 10/796,305 (US2004/0241521 A1), 10/849,503 (US2005/0260481 A1), 11/132,203 (US2006/0047983 A1), 10/959,763 (US2006/0078783 A1), 10/941,020 (US2006/0057435 A1), 11/226,222 (US2006/0057437 A1), US2002/0076602 A1, US2002/0142196 A1, US2003/0099876 A1, 11/325,466, 11/325,326, 11/384,364, 11/452,199, 11/384,365, 11/475,063, 11/476,571, 11/476,568, 11/668,761, 11/684,328 and 11/684,497. The entire disclosures of all of these patents and patent applications are hereby expressly incorporated by reference herein.

The invention is also directed to a fuel cell system for portable devices (such as, e.g., cell phones, laptop computers, PDAs, Blackberrys, etc.).

The invention also relates to a cartridge system that activates the fuel cell system. By pressing together the cartridge and the fuel cell assembly, the power supply system can be fueled, i.e., activated, and made ready to generate power.

Alternative non-limiting methods for activating the fuel cell system can include the following: removing a safety tape member which acts to separate one portion of the fuel cell system from another portion of the fuel cell system and then squeezing the portions towards one another in a user's hand. This results in the transfer of contents from, for example, a cartridge such as a fuel/electrolyte module to the fuel cell; and removing a safety separator member which acts to separate one housing part of the fuel cell from another housing part of the fuel cell and then squeezing the housings towards one another in a user's hand. This results in the transfer of contents from the cartridge to the fuel cell assembly.

The cartridge or fuel/electrolyte module can contain a fuel concentrate, a liquid diluent for the fuel concentrate (preferably comprising water) and a liquid electrolyte. By way of non-limiting example, the fuel cell system can utilize fuels of the type disclosed in co-pending U.S. patent application Ser. No. 10/758,081.

The invention also contemplates that, once the fuel is depleted, the entire fuel cell assembly can be replaced with a new one. That is, the fuel cell system can be a single fueling (single use) system.

The fuel cell system can be a generally rectangular system module or can be a generally cylindrical system. Furthermore, the fuel cell system can utilize a single cell configuration, a double cell configuration, or even a multiple cell configuration.

According to one aspect of the invention, the cartridge (system) (the terms “cartridge”, “cartridge system” and “fuel/electrolyte module” are used interchangeably herein) can have the following characteristics: the fuel can be stored in the cartridge as a concentrate (e.g., paste) and a liquid diluent (solvent), analogous to the configurations disclosed in U.S. patent application Ser. Nos. 10/824,443 and 10/758,081. The cartridge can also include a (liquid or gel) electrolyte or a component thereof.

According to one aspect of the invention, the fuel cell system can also have the following characteristic: a power management system utilizing a current chipset which can be restructured to optimally handle more than one cell.

The fuel/electrolyte module may preferably be divided into at least two separate chambers (sections); one chamber contains fuel concentrate (e.g., a paste-like, relatively high viscosity mass), and another chamber contains liquid diluent for the concentrate which in combination with the concentrate affords the desired fuel. A third chamber can be provided in the fuel/electrolyte module for storing an electrolyte (for example, an aqueous solution comprising one or more inorganic hydroxides such as, e.g., LiOH, NaOH, KOH, RbOH, CsOH, Ca(OH)₂, Mg(OH)₂, Ba(OH)₂, Zn(OH)₂, and Al(OH)₃, usually at least NaOH and/or KOH). Each chamber preferably has a sealable opening and/or an opening which can be accessed to allow the transfer of the contents of the cartridge into the appropriate or corresponding chambers in the fuel cell assembly.

The liquid fuel or concentrate thereof may comprise a hydride compound such as, e.g., one or more of LiH, NaH, KH, CaH₂, BeH₂, MgH₂, NaAlH₄, LiAlH₄ and KAliH₄ and/or a borohydride compound. For example, the liquid fuel may comprise one or more borohydride compounds. The one or more borohydride compounds may be selected from, e.g., NaBH₄, KBH₄, LiBH₄, NH₄BH₄, Be(BH₄)₂, Ca(BH₄)₂, Mg(BH₄)₂, Zn(BH₄)₂, Al(BH₄)₃, polyborohydrides, (CH₃)₃NBH₃, and NaCNBH₃. Further, the liquid fuel may comprise one or more borohydride compounds in a total concentration of at least about 0.5 mole per liter of concentrate, e.g., at least about 1 mole, at least about 2 moles, or at least about 3 moles per liter of concentrate.

The liquid diluent for the concentrate may, for example, comprise one or more of water, (cyclo)aliphatic alcohols having up to about 6 carbon atoms and up to about 6 hydroxy groups, C₂₋₄ alkylene glycols, di(C₂₋₄ alkylene glycols), poly(C₂₋₄ alkylene glycols), mono-C₁₋₄-alkyl ethers of C₂₋₄ alkylene glycols, di(C₂₋₄ alkylene glycols) and poly(C₂₋₄ alkylene glycols), di-C₁₋₄-alkyl ethers of C₂₋₄ alkylene glycols, di(C₂₋₄ alkylene glycols) and poly(C₂₋₄ alkylene glycols), ethylene oxide/propylene oxide block copolymers, ethoxylated aliphatic polyols, propoxylated aliphatic polyols, ethoxylated and propoxylated aliphatic polyols, aliphatic ethers having up to about 6 carbon atoms, aliphatic ketones having up to about 6 carbon atoms, aliphatic aldehydes having up to about 6 carbon atoms, C₁₋₄-alkyl esters of C₁₋₄ alkanoic (aliphatic) acids and primary, secondary and tertiary aliphatic amines having a total of up to about 10 carbon atoms, for example, at least one of water, methanol, ethanol, propanol, isopropanol, ethylene glycol, diethylene glycol, 1,2,4-butanetriol, trimethylolpropane, pentaerythritol, sorbitol, glycerol, acetone, methyl ethyl ketone, diethyl ketone, methyl acetate, ethyl acetate, dioxan, tetrahydrofuran, diglyme, triglyme, monoethanolamine, diethanolamine, triethanolamine, monopropanolamine, dipropanolamine and tripropanolamine). An optional third chamber can be provided in the cartridge for storing liquid electrolyte. Each chamber may have a sealable opening and/or an opening which can be accessed to allow the transfer of the contents of the cartridge into the appropriate corresponding chambers in the fuel cell assembly.

A number of non-limiting options for storing the components in the cartridge chambers may utilize any combination of the following features: one or more of the chambers can be a flexible housing containing a upper seal tab and a punctureable sealing member; one or more of the chambers can have the form of a bag containing one of the components; one or more of the chambers can be a flexible or deformable housing which houses a puncturing device and one of the components which will be transferred to either a fuel chamber or an electrolyte chamber of the fuel cell assembly; one or more of the chambers can be a non-rigid, “concertina” housing that can be compressed vertically with any one of the above-noted options.

The components of the fuel cell system of the present invention will preferably be produced primarily from lightweight, low-cost materials. Due to cost considerations, the components will preferably be made of polymer materials which are capable of withstanding (prolonged) exposure to the chemicals contained in the cartridge and/or the fuel cell assembly. Preferred examples of polymer materials include, but are not limited to (optionally filled) plastic materials such as PVC, PP, ABS, polycarbonate, polyurethane, etc. In practice, substantially all components (other than those with specific mechanical requirements, if any) are preferably made from such polymer materials. Of course, other materials can be used as well, such as, e.g., metals or alloys thereof (e.g., aluminum, chromium, nickel, titanium, copper, steel, brass, etc.). It also is possible, for example, to use polymer materials for some components or parts of the system and other materials such as, e.g. metals or alloys thereof, for other parts or components of the system.

Non-limiting ways of activating the fuel cell assembly can include manually pressing together the fuel/electrolyte module and the fuel cell assembly. The contents of the fuel/electrolyte module can then be caused and/or allowed to transfer from the module chambers to the proper chambers of the fuel cell assembly. This can occur using sealed connection ports to provide the required interface between the fuel/electrolyte module and the fuel cell assembly. Preferably, no valves are used and instead a puncturable sealing tab is utilized that, when punctured, allows the contents of the fuel/electrolyte module to directly transfer into the proper chambers of the fuel cell assembly.

The cartridge chambers can have the form of a one-piece three-chamber flexible material housing member which is connected to a cover having three ports. Each port is sealed with a puncturable seal tab. Each of the chambers includes a puncturing member which is moved to puncture the sealing tab when the chamber is deformed by a certain amount. Each puncturing member can have a sharp puncturing component such that when a portion of the puncturing member is caused to pivot to a certain extent, the sealing tab is punctured by the puncturing tip.

By way of non-limiting example, the puncturing tip can be V-shaped or have the form of a dagger.

The mixing of the fuel components (concentrate and diluent) can be performed immediately before use, e.g., immediately after transfer from the cartridge to the fuel cell assembly. This mixing process can, for example, be performed during the transfer process by puncturing both the seal tabs that divide the concentrate from its diluent. Gravitational force can also be utilized to permit the contents, e.g., fuel concentrate, diluent and electrolyte, to enter the fuel cell assembly.

Preferably, the arrangement is such that movement of the cartridge and the fuel cell assembly towards each other causes the sharp points of the puncturing devices to puncture the seal tabs and to release substantially simultaneously the entire contents of the cartridge chambers into the appropriate chambers of the fuel cell assembly.

The movement towards each other of the cartridge and the fuel cell assembly can be accomplished in a controlled manner by a sliding engagement between outer surfaces of one housing part slidably engaging inner surfaces of another housing part. When fully connected together, a shoulder or edge of one of the housing parts contacts a shoulder or edge of another housing part.

One way in which the movement can occur is by the user removing a safety member and then squeezing together, within his/her hand, two housing parts of the fuel cell system.

The invention also provides for a fuel cell system comprising a fuel cell assembly comprising an anode and a cathode, a fuel/electrolyte module comprising fuel and/or electrolyte and/or components thereof, a housing arrangement housing the fuel cell assembly and the fuel/electrolyte module, and a system for transferring at least some of the contents of the fuel/electrolyte module into the fuel cell assembly.

The fuel cell system may be at least one of a stand-alone unit, a modular unit, and a portable unit. The fuel/electrolyte module may comprise a plurality of separate chambers. The fuel/electrolyte module may comprise a plurality of separate chambers each having a sealed opening. The fuel/electrolyte module may comprise a fuel concentrate chamber, an electrolyte chamber, and a diluent chamber. The fuel/electrolyte module may comprise flexible material chambers. The fuel/electrolyte module may comprise a plurality of separate chambers and a plurality of ports, each port being in fluid communication with one of the separate chambers. The fuel/electrolyte module may comprise a plurality of separate sealed chambers and a plurality of ports, each port being in fluid communication with one of the separate chambers. The fuel/electrolyte module may comprise a plurality of separate variable volume chambers and a plurality of ports, each port being in fluid communication with one of the separate chambers. The fuel/electrolyte module may comprise a plurality of separate flexible chambers and a plurality of ports, each port being in fluid communication with one of the separate chambers. The fuel/electrolyte module may comprise a plurality of separate sealed chambers and a plurality of puncturing members, each puncturing member being capable of puncturing a sealing member when the chambers experience a compressive force. The fuel/electrolyte module may comprise a plurality of separate sealed chambers and a plurality of puncturing members, each puncturing member being capable of puncturing a sealing member when the chambers experience deformation forces. The fuel/electrolyte module may comprise a plurality of separate sealed chambers and a plurality of puncturing members, each puncturing member being capable of puncturing a sealing member when the chambers experience an internal volume reduction. The fuel/electrolyte module may comprise a plurality of separate sealed chambers and a plurality of puncturing members, each puncturing member being capable of moving from a first position to a second position which causes puncturing of a sealing member. The fuel/electrolyte module may comprise at least one puncturable separating wall. The fuel/electrolyte module may comprise at least one puncturable cap. The fuel/electrolyte module may comprise at least one puncturable separating wall dividing a chamber of the fuel/electrolyte module from a port of the fuel/electrolyte module. The fuel/electrolyte module may comprise at least one puncturable separating wall dividing each chamber of the fuel/electrolyte module from each port of the fuel/electrolyte module.

The fuel cell assembly may comprise an anode frame assembly and a cathode frame assembly. The fuel cell assembly may comprise substantially empty chambers which are capable of receiving fuel and/or electrolyte and/or components thereof when the system for transferring at least some of the contents of the fuel/electrolyte module into the fuel cell assembly causes transferring. The fuel cell assembly may comprise a plurality of separate substantially empty chambers. The fuel cell assembly may comprise a fuel chamber and an electrolyte chamber. The system for transferring at least some of the fuel components of the fuel/electrolyte module into the fuel cell assembly may comprise the housing arrangement. The housing arrangement may comprise first and second housing parts which move towards each other during activation of the system for transferring. The housing arrangement may comprise first and second housing parts which slide relative to each other during activation of the system for transferring. The system for transferring may be capable of causing movement of puncturing members. The system for transferring may comprise opposing surfaces which, when moved towards each other, cause puncturing members to puncture sealing members. The system for transferring may comprise opposing surfaces which, when moved towards each other, cause movement of puncturing members arranged within chambers of the fuel/electrolyte module. The system for transferring may comprise opposing surfaces which, when moved towards each other, cause compression of chambers of the fuel/electrolyte module. The system for transferring may comprise opposing surfaces which, when moved towards each other, cause volume reduction of chambers of the fuel/electrolyte module. The system for transferring may comprise opposing surfaces which, when moved towards each other, cause deformation of chambers of the fuel/electrolyte module. The system for transferring may be capable of forcing at least a part of the contents of the fuel/electrolyte module into the fuel cell assembly. The system for transferring may be capable of forcing at least a part of the contents of the fuel/electrolyte module arranged in separate chambers of the fuel/electrolyte module into appropriate chambers of the fuel cell assembly. The system for transferring may be capable of forcing at least a part of the contents of the fuel/electrolyte module arranged in three separate chambers of the module into two chambers of the fuel cell assembly. The housing arrangement may comprise a first housing part and a second housing part wherein the first housing part comprises outer surfaces which slidably engage inner surfaces of the second housing part. The fuel cell assembly may comprise a least one fuel chamber and at least one electrolyte chamber.

The system may further comprise at least one device for puncturing a puncturable separating wall and/or at least one puncturable cap. The housing arrangement may be generally rectangular. The system may further comprise a system for coupling each chamber of the fuel/electrolyte module to an appropriate chamber in the fuel cell assembly. The system may further comprise a system for delivering, feeding, or conveying the fuel components of each chamber of the fuel/electrolyte module to an appropriate chamber in the fuel cell assembly. The system may further comprise a plurality of ports and receiving openings which are in fluid communication with each other.

The invention also provides for a method of generating electrical power using a fuel cell system of the type described herein, wherein the method comprises at least one of: subjecting the housing arrangement to compression to cause at least a part of the contents of the fuel/electrolyte module to transfer from the fuel/electrolyte module to the fuel cell assembly; gripping and squeezing the housing arrangement to cause at least a part of the contents of the fuel/electrolyte module to transfer from the fuel/electrolyte module to the fuel cell assembly; and moving two portions of the housing arrangement relative to each other to cause at least a part of the contents of the fuel/electrolyte module to transfer from the fuel/electrolyte module to the fuel cell assembly.

The method may further comprise, before transfer, storing the fuel and/or fuel components and/or the electrolyte and/or electrolyte components in the fuel/electrolyte module. The method may further comprise, before transfer, storing the fuel, electrolyte and/or components thereof only in the fuel/electrolyte module. The method may further comprise, before transfer, storing the fuel, electrolyte and/or components thereof in separate chambers of the fuel/electrolyte module. The method may further comprise, before transfer, storing the fuel, electrolyte and/or components thereof only in separate chambers of the fuel/electrolyte module. The method may further comprise, before the transfer, connecting the fuel/electrolyte module and the fuel cell assembly. The method may further comprise, before the transfer, connecting ports of the fuel/electrolyte module to chambers of the fuel cell assembly. The method may further comprise, before the transfer, connecting sealed ports of the fuel/electrolyte module to chambers of the fuel cell assembly. The method may further comprise, before the transfer, puncturing sealing members of the fuel/electrolyte module. The method may further comprise, immediately before the transfer, puncturing sealing members of each chamber of the fuel/electrolyte module. The transfer may occur only after sealing members are punctured. The method may further comprise removing a safety member acting to prevent the transfer. The method may further comprise removing a safety member acting to prevent relative movement of portions of the housing arrangement. The method may further comprise, before the transfer, connecting at least one port of the fuel/electrolyte module to at least one port opening of the fuel cell assembly. The method may further comprise, before the transfer, connecting a plurality of ports of the fuel/electrolyte module to a plurality of port openings of the fuel cell assembly. The method may further comprise, before the transfer, connecting in a sealing manner a plurality of ports of the fuel/electrolyte module to a plurality of port openings of the fuel cell assembly.

The invention also provides for a fuel cell system comprising a housing arrangement, a fuel cell assembly comprising an anode and a cathode, a fuel/electrolyte module comprising fuel, electrolyte and/or components thereof, and a device that, in a first position, prevents transfer of at least some of the contents of the fuel/electrolyte module from the module into the fuel cell assembly and that, in a second position, allows transfer of at least some of the contents of the fuel/electrolyte module from the module into the fuel cell assembly, wherein the fuel cell assembly and the fuel/electrolyte module are arranged within the housing arrangement.

The fuel cell system may be at least one of a stand-alone unit, a modular unit, and a portable unit. The fuel/electrolyte module may comprise a plurality of separate chambers. The fuel/electrolyte module may comprise a plurality of separate chambers each having a sealed opening. The fuel/electrolyte module may comprise a fuel concentrate chamber, an electrolyte chamber, and a liquid diluent chamber. The fuel/electrolyte module may comprise flexible material chambers. The fuel/electrolyte module may comprise a plurality of separate chambers and a plurality of ports, each port being in fluid communication with one of the separate chambers. The fuel/electrolyte module may comprise a plurality of separate sealed chambers and a plurality of ports, each port being in fluid communication with one of the separate chambers. The fuel/electrolyte module may comprise a plurality of separate variable volume chambers and a plurality of ports, each port being in fluid communication with one of the separate chambers. The fuel/electrolyte module may comprise a plurality of separate flexible chambers and a plurality of ports, each port being in fluid communication with one of the separate chambers. The fuel/electrolyte module may comprise a plurality of separate sealed chambers and a plurality of puncturing members, each puncturing member being capable of puncturing a sealing member when the chambers experience compressive forces. The fuel/electrolyte module may comprise a plurality of separate sealed chambers and a plurality of puncturing members, each puncturing member being capable of puncturing a sealing member when the chambers experience deformation forces. The fuel/electrolyte module may comprise a plurality of separate sealed chambers and a plurality of puncturing members, each puncturing member being capable of puncturing a sealing member when the chambers experience internal volume reduction. The fuel/electrolyte module may comprise a plurality of separate sealed chambers and a plurality of puncturing members, each puncturing member being capable of moving from a first position to a second position which causes puncturing of a sealing member.

The fuel cell assembly may comprise an anode frame assembly and a cathode frame assembly. The fuel cell assembly may comprise a plurality of separate substantially empty chambers. The fuel cell assembly may comprise a fuel chamber and an electrolyte chamber. The housing arrangement may comprise a system for transferring at least some of the contents of the fuel/electrolyte module into the fuel cell assembly. The housing arrangement may comprise first and second housing parts which move towards each other. The housing arrangement may comprise first and second housing parts which slide relative to each other.

The system may further comprise a system for transferring the contents of the fuel/electrolyte module from the module to the fuel cell assembly, wherein said system is capable of causing movement of puncturing members. The system for transferring may comprise opposing surfaces which, when moved towards each other, cause the puncturing members to puncture sealing members. The system for transferring may comprise opposing surfaces which, when moved towards each other, cause movement of the puncturing members arranged within chambers of the fuel/electrolyte module.

The system may further comprise a system for transferring at least a part of the contents of the fuel/electrolyte module from the module to the fuel cell assembly, wherein said system comprises opposing surfaces which, when moved towards each other, cause compression of chambers of the fuel/electrolyte module. The system may further comprise a system for transferring the fuel components from the fuel/electrolyte module to the fuel cell assembly, wherein said system comprises opposing surfaces which, when moved towards each other, cause a volume reduction of chambers of the fuel/electrolyte module. The system may further comprise a system for transferring the fuel components from the fuel/electrolyte module to the fuel cell assembly, wherein said system comprises opposing surfaces which, when moved towards each other, cause a deformation of chambers of the fuel/electrolyte module. The system may further comprise a system for transferring the fuel components from the fuel/electrolyte module to the fuel cell assembly, wherein said system is capable of forcing at least a part of the contents of the fuel/electrolyte module into the fuel cell assembly. The system may further comprise a system for transferring at least a part of the contents of the fuel/electrolyte module from the module to the fuel cell assembly, wherein said system is capable of forcing the contents of the fuel/electrolyte module arranged in separate chambers of the module into appropriate chambers of the fuel cell assembly. The system may further comprise a system for transferring the contents of the fuel/electrolyte module from the module to the fuel cell assembly, wherein the system is capable of forcing at least a part of the contents arranged in three separate chambers of the fuel/electrolyte module into two (empty) chambers of the fuel cell assembly. The housing arrangement may comprise a first housing part and a second housing part, and wherein the first housing part comprises outer surfaces which slidably engage inner surfaces of the second housing part.

The fuel cell assembly may comprise a least one fuel chamber and at least one electrolyte chamber. The fuel/electrolyte module may comprise at least one puncturable separating wall. The fuel/electrolyte module may comprise at least one puncturable cap. The fuel/electrolyte module may comprise at least one puncturable separating wall dividing a chamber of the fuel/electrolyte module from a port of the fuel/electrolyte module. The fuel/electrolyte module may comprise at least one puncturable separating wall dividing each chamber of the fuel/electrolyte module from each port of the fuel/electrolyte module. The system may further comprise at least one device for puncturing a puncturable separating wall and/or at least one puncturable cap.

The housing arrangement may be generally rectangular. The system may further comprise a system for coupling each chamber of the fuel/electrolyte module to an appropriate chamber in the fuel cell assembly. The system may further comprise a system for delivering, feeding and/or conveying at least a part of the contents of each chamber of the fuel/electrolyte module to an appropriate chamber in the fuel cell assembly. The system may further comprise a plurality of ports and receiving openings which are in fluid communication with each other.

The invention also provides for a method of generating electrical power using the system described herein, wherein the method comprises at least one of subjecting the housing arrangement to compression to cause at least some of the contents of the fuel/electrolyte module to transfer from the module to the fuel cell assembly, gripping and squeezing the housing arrangement to cause at least some of the contents of the fuel/electrolyte module to transfer from the module to the fuel cell assembly, and moving two portions of the housing arrangement relative to each other to cause at least some of the contents of the fuel/electrolyte module to transfer from the module to the fuel cell assembly.

The invention is also directed to a handy and disposable charger/portable auxiliary power source for small, portable electronic devices, based on a Direct Liquid Fuel cell (DLFC). Preferably, the device can utilize multiple connectors to start recharging or continue powering the battery in a device such as, e.g., a cell phone or a laptop, in seconds, giving continuous use—all the way through to a full charge.

The invention is preferably also capable of providing extended operating time for devices such as mobile phones up to, e.g., 30 hours talk time, 60-80 hours use time for certain iPods, and many hours of use for various other mobile devices.

Additionally, the invention is preferably capable of immediate use while charging, safe to use (not flammable, not toxic), environmentally friendly, i.e., it utilizes no mercury or other environmentally harmful metals, has a convenient size and is lightweight, is cost effective, and can bridge the power gap for 3G & 4G cell phones with a full range of functionality, dual mode phones for WiFi and Voice Over Internet (VoIP), smart phones (iMate etc.), camera phones, iPods & MP3s, Game Boys, Personal Digital Assistants (PDAs), Blackberries, digital cameras, RAZR and a broad array of military applications.

Until now, most traditional fuel cells for portable electronic devices have used methanol as their fuel in Direct Methanol Fuel Cells ((DMFCs) and a solid, Proton Exchange Membrane or PEM. The DMFC generally uses expensive noble metals in its electrodes, with the PEM requiring add-on support systems such as water management and forced air systems or reformer. The invention, on the other hand, does not require surplus systems and can be made with reduced overall costs associated with DMFCs and eliminating PEM systems.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a top perspective view of a first embodiment of a fuel cell system which includes a fuel cell, a cartridge, and a system for activating the fuel cell;

FIG. 2 shows a side view of the embodiment of FIG. 1;

FIG. 3 shows a bottom view of the embodiment of FIG. 1;

FIG. 4 shows a side view of the embodiment of FIG. 1 with the activating system tab member removed. The fuel cell is shown ready to be activated by moving the cover and base towards each other;

FIG. 5 shows a bottom view of the embodiment of FIG. 1 illustrating how the tab member is broken apart by pulling on the pull-tab;

FIG. 6 shows the fuel cell of FIG. 4 after it is activated by moving the cover and base towards each other;

FIG. 7 shows a bottom view of the fuel cell shown in FIG. 6;

FIG. 8 shows a partially exploded view of the embodiment of FIG. 1 and illustrates the cover, the module and bladder system, the removable tab, the bladder divider, the base, and the label;

FIG. 9 shows a top perspective view of the cover used in the embodiment shown in FIG. 1;

FIG. 9a shows an enlarged view of a portion of FIG. 9;

FIG. 10 shows a bottom perspective view of the cover used in the embodiment shown in FIG. 1;

FIG. 10a shows an enlarged view of a portion of FIG. 10;

FIG. 10b shows an enlarged view of a portion of FIG. 10;

FIG. 10c shows an enlarged view of a portion of FIG. 10;

FIG. 11 shows a top side perspective view of the inner plate used in the embodiment shown in FIG. 1;

FIG. 11a shows an enlarged view of a portion of FIG. 11;

FIG. 12 shows a bottom side perspective view of the inner plate (with a section thereof missing) used in the embodiment shown in FIG. 1;

FIG. 12a shows an enlarged view of a portion of FIG. 12;

FIG. 12b shows an enlarged view of a portion of FIG. 12;

FIG. 12c shows an enlarged view of a portion of FIG. 12;

FIG. 13 shows a partially exploded view of the cover and inner plate prior to the inner plate being assembled to the cover;

FIG. 14 shows the inner plate assembled to the cover;

FIG. 15 shows a bottom side perspective view of the base used in the embodiment shown in FIG. 1;

FIG. 16 shows a top side perspective view of the base shown in FIG. 15;

FIG. 16a shows an enlarged view of a portion of FIG. 16;

FIG. 16b shows an enlarged view of a portion of FIG. 16;

FIG. 17 shows a top side perspective view of the tab member used in the embodiment shown in FIG. 1;

FIG. 17a shows an enlarged view of a portion of FIG. 17;

FIG. 18 shows a side view of the tab member shown in FIG. 17;

FIG. 19 shows a bottom side perspective view of the tab member shown in FIG. 17;

FIG. 20 shows a top side perspective view of the module and bladder system used in the embodiment shown in FIG. 1. An absorbent member is shown positioned between the module and bladder system;

FIG. 21 shows an exploded view of FIG. 20 and shows the module, the bladder system, and the absorbent member positioned between the module and bladder system;

FIG. 22 shows a top side perspective view of the module used in the embodiment shown in FIG. 1;

FIG. 23 shows a top side perspective view of the module shown in FIG. 22 with the circuit board in an uninstalled position;

FIG. 24 shows a top rear side perspective view of the module shown in FIG. 22 with the circuit board removed;

FIG. 25 shows an exploded view of FIG. 24 and shows an upper portion of the module separated from a lower portion of the module. The upper portion includes the top frame, the cathode frame and the anode frame and the lower portion includes the extension frame and the bottom frame;

FIG. 26 shows a top rear side perspective view of the upper portion of the module shown in FIG. 25;

FIG. 27 shows an exploded view of FIG. 26 and shows the top frame and the cathode frame arranged above and separated from the anode frame;

FIG. 28 shows a bottom rear side perspective view of the upper portion of the module shown in FIG. 25;

FIG. 29 shows the upper portion of FIG. 28 with an anode regulating mesh member arranged above and separated from the top portion;

FIG. 30 shows a top view of FIG. 29 with the anode regulating mesh member secured to and within a bottom main recess of the anode frame via welding;

FIG. 31 shows a top view of the anode regulating mesh member used in the embodiment of FIG. 1;

FIG. 32 shows a top rear side perspective view of an upper portion shown in FIG. 27 and including the top frame and the cathode frame;

FIG. 33 shows an exploded view of FIG. 32 and shows the top frame arranged above and separated from the cathode frame;

FIG. 34 shows a top side perspective view of the lower portion shown in FIG. 25 and including the extension frame and the bottom frame;

FIG. 35 shows an exploded view of FIG. 34 and shows the extension frame arranged above and separated from the bottom frame;

FIG. 36 shows a top side perspective view of the top frame assembly used in the embodiment of FIG. 1;

FIG. 37 shows a bottom side perspective view of the top frame assembly shown in FIG. 36;

FIG. 38 shows a top side perspective view of the top frame shown in FIG. 36 prior to the formation of a rib structure formed by overmolding;

FIG. 39 shows a bottom side perspective view of the top frame shown in FIG. 38;

FIG. 40 shows a top side perspective view of the top frame shown in FIG. 38 prior to the installation of the vent membrane members;

FIG. 41 shows a bottom side perspective view of the top frame shown in FIG. 40;

FIG. 42 shows a top side perspective view of the cathode frame assembly used in the embodiment of FIG. 1;

FIG. 43 shows a bottom side perspective view of the cathode frame assembly shown in FIG. 42;

FIG. 44 shows an exploded view of FIG. 45 and shows the cathode assembly arranged above and separated from the cathode frame;

FIG. 45 shows a bottom side perspective view of the cathode assembly assembled to the cathode frame and prior to the formation of a securing encapsulating material;

FIG. 46 shows a top side perspective view of the cathode used in the embodiment of FIG. 1;

FIG. 47 shows a top side perspective view of the cathode electrode used in the embodiment shown in FIG. 1;

FIG. 48 shows a top side perspective view of the anode frame assembly used in the embodiment of FIG. 1;

FIG. 48a shows an enlarged view of a portion of FIG. 48;

FIG. 49 shows an exploded view of FIG. 50 and shows the anode assembly arranged above and separated from the anode frame;

FIG. 50 shows a top side perspective view of the anode assembly assembled to the anode frame and prior to the formation of a securing encapsulating material;

FIG. 51 shows a top side perspective view of the anode frame used in the embodiment of FIG. 1;

FIG. 51a shows an enlarged view of a portion of FIG. 51;

FIG. 52 shows a bottom side perspective view of the anode frame shown in FIG. 51;

FIG. 52a shows an enlarged view of a portion of FIG. 52;

FIG. 52b shows an enlarged view of a portion of FIG. 52;

FIG. 53 shows a top side perspective view of the anode assembly used in the embodiment of FIG. 1;

FIG. 53a shows an enlarged view of a portion of FIG. 53;

FIG. 54 shows a top view of the anode assembly shown in FIG. 53;

FIG. 55 shows a side view of the anode assembly shown in FIG. 53;

FIG. 55a shows an enlarged view of a portion of FIG. 55;

FIG. 56 shows a top side perspective view of the anode used in the embodiment of FIG. 1;

FIG. 57 shows a top side perspective view of the anode electrode used in the embodiment shown in FIG. 1;

FIG. 58 shows a top side perspective view of the extension frame used in the embodiment of FIG. 1;

FIG. 59 shows a bottom side perspective view of the extension frame shown in FIG. 58;

FIG. 60 shows a top side perspective view of the bottom frame assembly used in the embodiment of FIG. 1;

FIG. 61 shows a bottom side perspective view of the bottom frame assembly shown in FIG. 60;

FIG. 62 shows a top side perspective view of the bottom frame shown in FIG. 60 prior to the formation of a rib structure formed by overmolding;

FIG. 63 shows a bottom side perspective view of the bottom frame shown in FIG. 62;

FIG. 64 shows a top side perspective view of the bladder system used in the embodiment of FIG. 1;

FIG. 65 shows a top view of the bladder system shown in FIG. 65 and illustrates the fill openings are sealed with welded on sealing members;

FIG. 66 shows a bottom view of the bladder system shown in FIG. 64 and illustrates how the bladder member is welded onto the bladder plate;

FIG. 67 shows a top view of the bladder plate used in bladder system shown FIG. 64 prior to installation of the inlet opening sealing members;

FIG. 68 shows a cross-section view of FIG. 67;

FIG. 69 shows a top perspective view of the bladder member used in bladder system shown in FIG. 64;

FIG. 70 shows a bottom perspective view of the bladder member shown in FIG. 69;

FIG. 71 shows a bottom view of the bladder plate used in the bladder system shown FIG. 64 and illustrates the weld areas of the exit opening seal members;

FIG. 72 shows a bottom view of the bladder plate used in the bladder system shown FIG. 64 and illustrates how the exit opening seal members are formed;

FIG. 73 shows a cross-section view of FIG. 72;

FIG. 74 shows a bottom perspective view of the bladder plate of FIG. 71 with the puncturing devices installed;

FIG. 75 shows an end view of FIG. 74;

FIG. 75a shows an enlarged view of a portion of FIG. 75;

FIG. 76 shows a bottom view of the bladder plate of FIG. 74;

FIG. 76a shows an enlarged view of a portion of FIG. 76;

FIG. 76b shows an enlarged view of a portion of FIG. 76a;

FIG. 77 shows a bottom perspective view of one of the outer nipple members used on the bladder system of FIG. 64;

FIG. 78 shows a top perspective view of FIG. 77;

FIG. 79 shows a top side perspective view of one of the puncturing devices used on the bladder system of FIG. 64;

FIG. 80 shows a bottom perspective view of FIG. 79;

FIG. 81 shows another top side perspective view of one of the puncturing devices used on the bladder system of FIG. 64;

FIG. 81a shows an enlarged view of a portion of FIG. 81;

FIG. 81b shows an enlarged view of a portion of FIG. 81;

FIG. 82 shows an end side perspective view of one of the puncturing devices used on the bladder system of FIG. 64;

FIG. 82a shows an enlarged view of a portion of FIG. 82;

FIG. 83 shows a top view of the absorbent member used on the bladder system of FIG. 64;

FIG. 84 shows an end view of the absorbent member shown in FIG. 83;

FIG. 84a shows an enlarged view of a portion of FIG. 84;

FIG. 85 shows a top perspective view of the absorbent member used on the bladder system of FIG. 64;

FIG. 86 shows a top view of the circuit board used on the embodiment of FIG. 1;

FIG. 87 shows an end view of FIG. 86;

FIG. 88 shows a bottom view of FIG. 86; and

FIG. 89 shows a top perspective view of the circuit board shown in FIG. 86.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

According to one non-limiting aspect of the invention, there is provided a handy and disposable charger/portable auxiliary power source for small, portable electronic devices, based on a Direct Liquid Fuel cell (DLFC). The device can utilize multiple connectors to start recharging or continue powering the battery in a device such as, e.g., a cell phone or a laptop, in seconds, giving continuous use—all the way through to a full charge.

The invention is also directed to a device that is capable of providing extended operating time for devices such as mobile phones up to, e.g., 30 hours talk time, 60-80 hours use time for certain iPods, and many hours of use for various other mobile devices.

The invention is also directed to a device that is capable of immediate use while charging, is safe to use (not flammable, not toxic), is environmentally friendly, i.e., it utilizes no mercury or other environmentally harmful metals, has a convenient size and is lightweight, is cost effective, and can bridge the power gap for 3G & 4G cell phones with a full range of functionality, dual mode phones for WiFi and Voice Over Internet (VoIP), smart phones (iMate etc.), camera phones, iPods & MP3s, Game Boys, Personal Digital Assistants (PDAs), Blackberries, digital cameras, RAZR and a broad array of military applications.

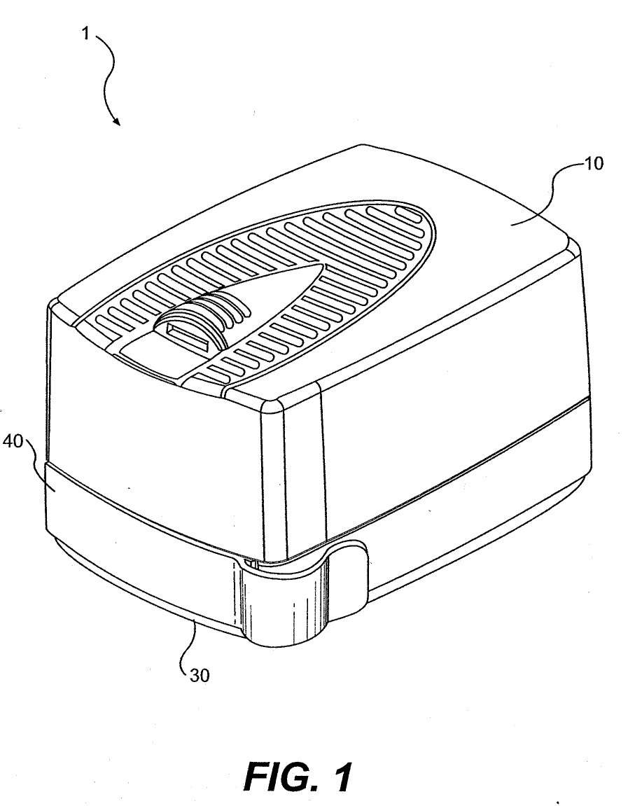

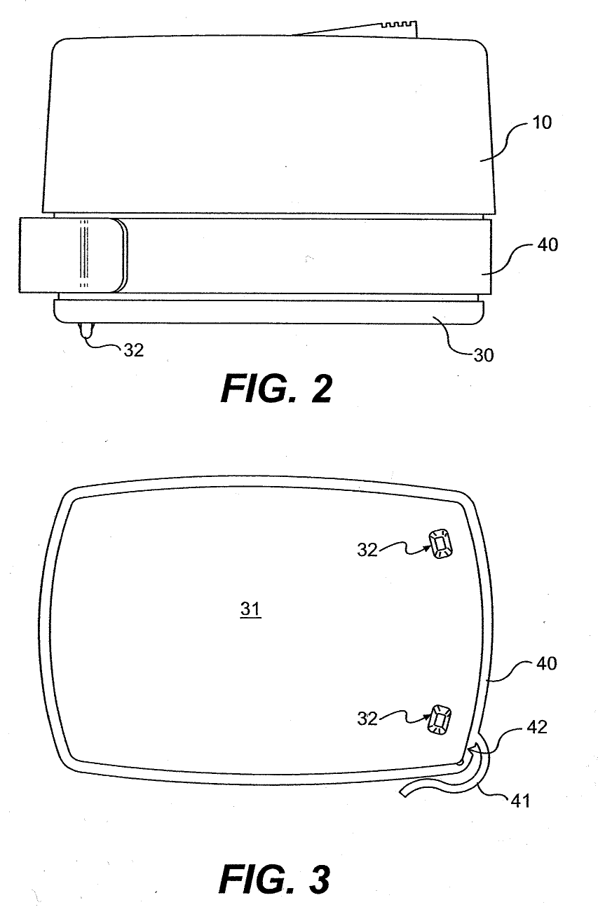

With reference to FIGS. 1-8, there is shown one non-limiting embodiments of a fuel cell device 1 whose main components include a cover 10, a base 30, a removable tab 40, a fuel cell module 60 and bladder system 50, a bladed divider 3, and an instruction label 2. The details of these devices as well as the functioning of the device 1 will be described in detail below.

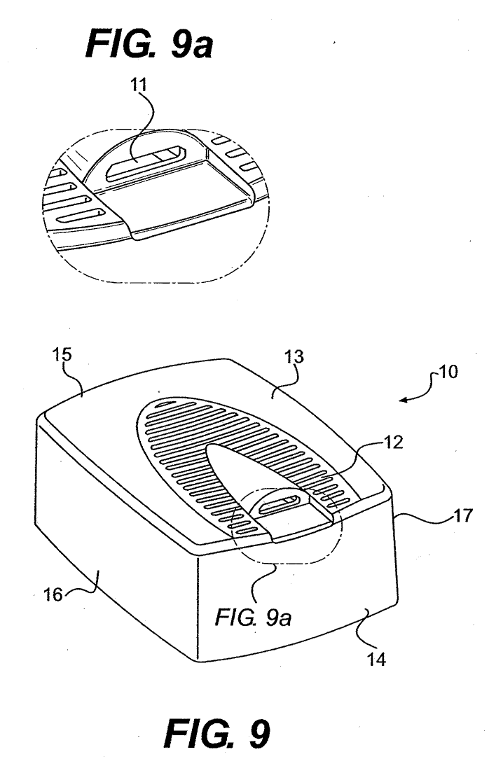

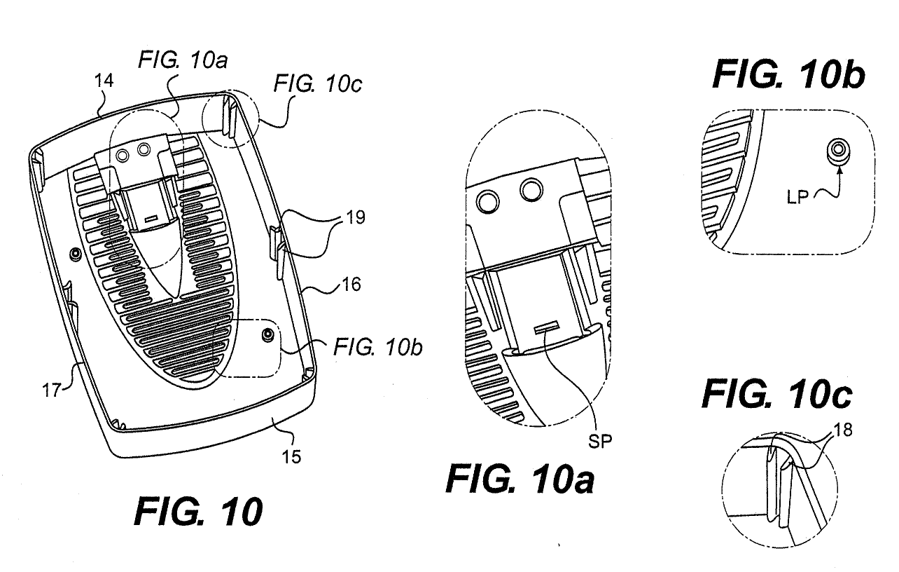

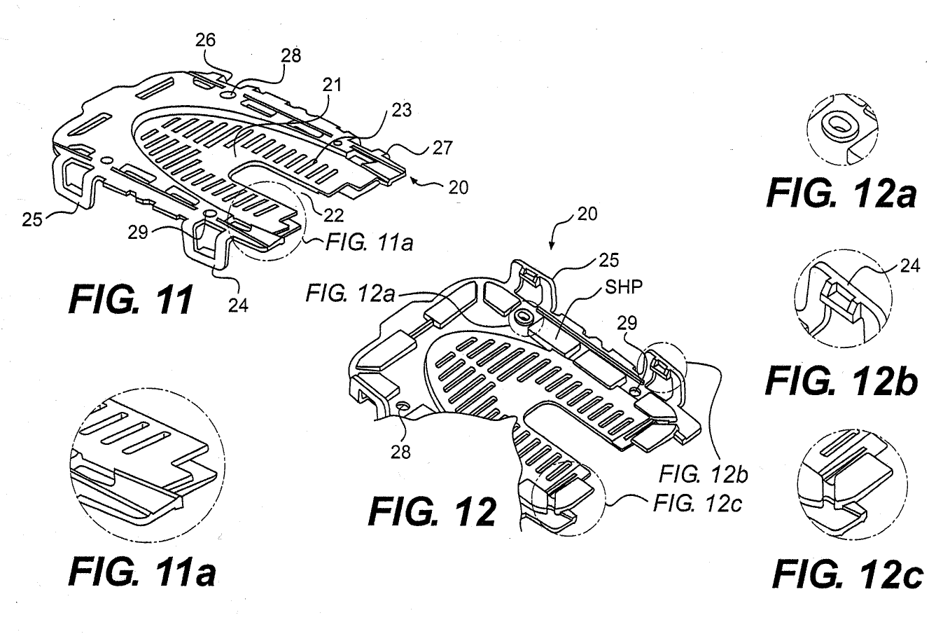

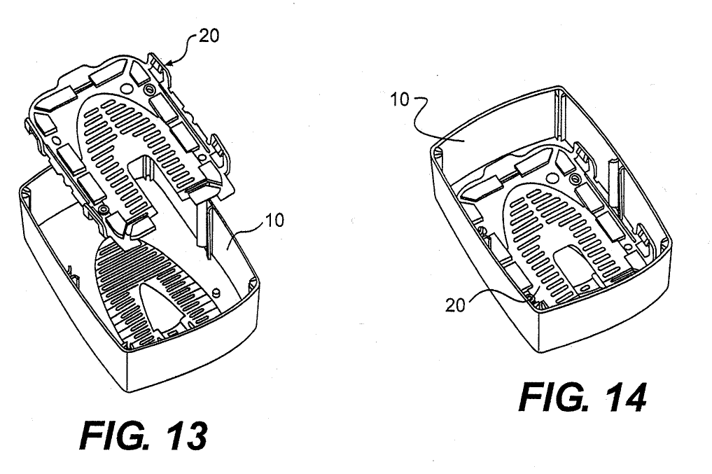

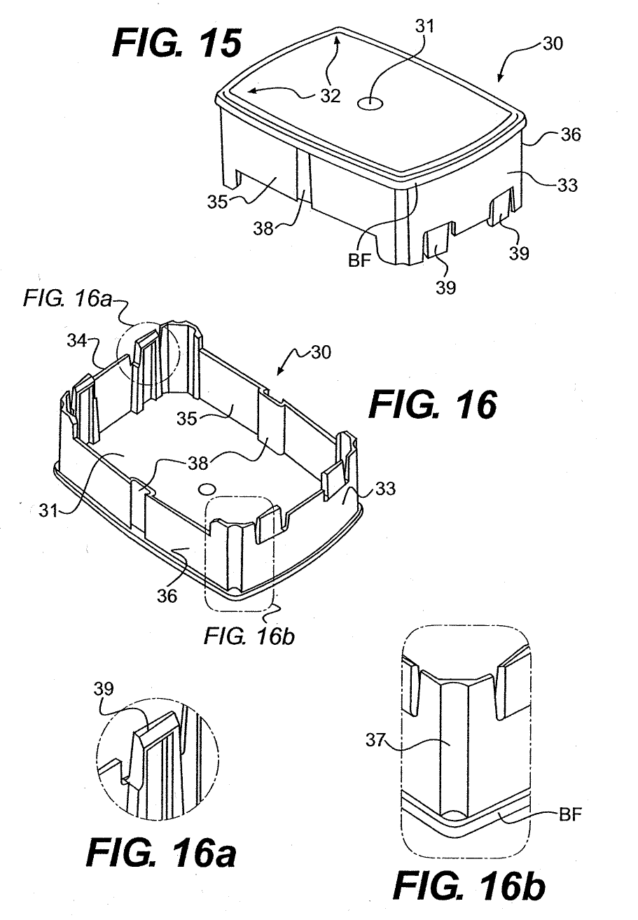

As can be seen in FIGS. 9 and 10, the cover 10 is a one-piece synthetic resin member having a generally rectangular shape defined by a top outwardly curved wall 13 having a connector opening 11 (see FIG. 9a) and a venting arrangement 12. The venting arrangement 12 includes a plurality of vent openings or slots. The cover 10 also includes four outwardly curved sidewalls 14-17. The oppositely arranged shorter sidewalls 14 and 15 are front and rear sidewalls whereas the longer sidewalls 16 and 17 are left and right side sidewalls. Within the cover 10, each inside corner includes two curved projections which together form a circular projection 18 (see FIG. 10c). The four corner projections 18 are sized and configured to slidably engage with four correspondingly shaped recesses 37 formed in the base 30 (see FIG. 16b). The two longer side walls 16 and 17 each include two curved projections 19 that curve away from each other and which form a guide rail 19 (see FIG. 10). The two oppositely arranged guide rails 19 are sized and configured to slidably engage with two oppositely arranged guide recesses 38 formed in the base 30 (see FIGS. 15 and 16). The sliding engagement of the guide recesses 37 and recesses 38 with the guide projections 18 and guide rails 19 function to provide a smooth and guided sliding movement of the cover 10 relative to the base 30. As will be described below, this movement occurs once the removable tab 40 is removed and the fuel cell 1 is activated. The bottom surface of the top wall 13 includes two locating projections LP (see FIG. 10b) which are sized and configured to engage with recesses 28 and 29 formed in an inner plate 20 (see FIG. 11). A stop projection SP (see FIG. 10a) is arranged to stop or limit inward movement of an electrical connector which will be inserted into the opening 11. Once the inner plate 20 is properly positioned against the bottom surface of the top wall 13 (see FIGS. 13 and 14), the inner plate 20 is secured to the bottom surface of the top wall 13 by e.g., ultrasonic welding or adhesive bonding. The material for the cover 10 can be, e.g., an ABS (Acrylonitrile Butadiene Styrene) copolymer. Exemplary non-limiting length, width and height sizes for the cover 10 can be, e.g., a length of about 100 mm, a width of about 70 mm and a height of 35 mm.

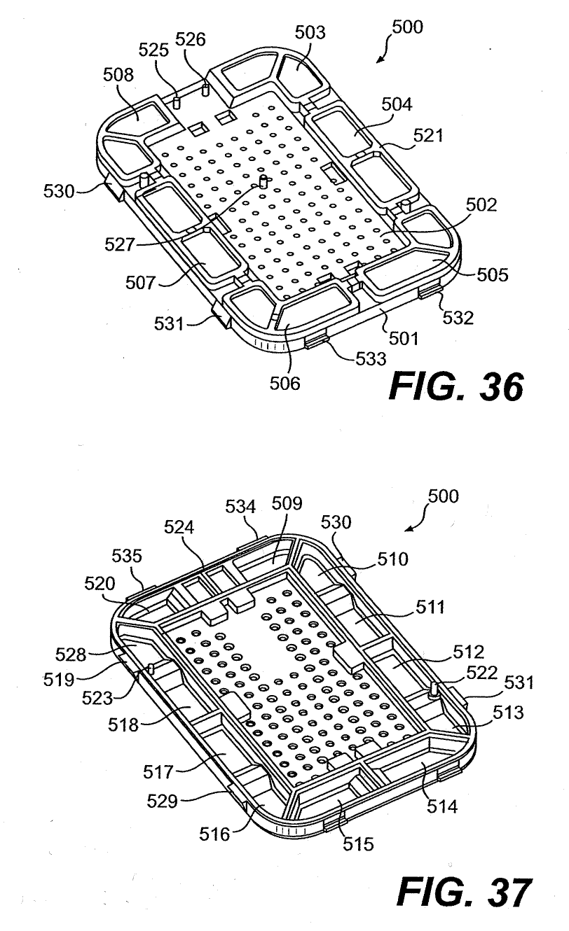

With reference to FIGS. 11 and 12, the inner plate 20 is a one-piece synthetic resin member having a generally rectangular shape defined by a top wall 21 having a main recess 22 and a venting arrangement 23 which generally corresponds in shape to the venting arrangement 12 of the cover 10. The venting arrangement 23 includes a plurality of vent openings or slots. The main recess 22 is sized and configured to allow the contact support 810 and the four contacts 801-804 of the circuit board 800 (see FIG. 87) to extend up therethrough so that a connector inserted in the connector opening 11 will make proper electrical contact with the contacts 801-804. The inner plate 20 also includes four perimeter locking arrangements 24-27 which are configured to lock with four locking projections 528-531 arranged on the top frame 500 (see FIGS. 36-37). When the four locking arrangements 24-27 are locked with the four locking projections 528-531 and when the inner plate 20 is fixed to the cover 10 (see FIG. 14), the module 60 becomes secured or fixed (e.g., non-removably secured) to the cover 10. The inner plate 20 also preferably includes an arrangement of twelve shallow projections SHP (see FIGS. 12 and 13) which are sized and configured to extend into the vent membrane recesses (defined by the vent membrane members 503-508 and the member 521) of the top frame 500 and contact the vent membranes 503-508. The material for the inner plate 20 can be, e.g., an ABS (Acrylonitrile Butadiene Styrene) copolymer.

With reference to FIGS. 15-16, the base 30 is a one-piece synthetic resin member having a generally rectangular shape defined by a bottom generally planar wall 31 having two support projections 32. The base 30 also includes four outwardly curved sidewalls 33-36. The oppositely arranged shorter sidewalls 33 and 34 are front and rear sidewalls whereas the longer sidewalls 35 and 36 are left and right side sidewalls. Each outside corner includes a curved recess 37 (see FIG. 16b). The four corner recesses 37 are sized and configured to slidably engage with four correspondingly shaped projections 18 formed in the cover 10 (see FIG. 10c). The two longer side walls 35 and 36 each include a dovetail shaped recess 38 which is sized and configured to slidably engage with two oppositely arranged guide rails 19 formed on the cover 10 (see FIG. 10). As explained above, the sliding engagement of the guide recesses 37 and 38 with the guide projections 18 and guide rails 19 functions to provide a smooth and guided sliding movement of the cover 10 relative to the base 30 once the removable tab 40 is removed and the fuel cell is activated. The front and back walls 33 and 34 each include two locking arrangements 39 (see FIG. 16a) which are sized and configured to engage with two locking projections 532-535 arranged on the top frame 500 (see FIGS. 36 and 37). When the four locking arrangements 39 are locked with the four locking projections 532-535 (which occurs when the cover 10 and base 30 are moved towards each other during activation of the fuel cell 1), the module 60 (as well as the cover 10) becomes locked, secured or fixed (e.g., non-removably secured) to the base 30. A bottom flange BF extends around a perimeter of the base 30 and serves to support the bottom edge of the tab member 40. The material for the base 30 can be, e.g., an ABS copolymer. Exemplary non-limiting length, width and height sizes for the cover base can be, e.g., a length of about 100 mm, a width of about 70 mm and a height of about 35 mm.

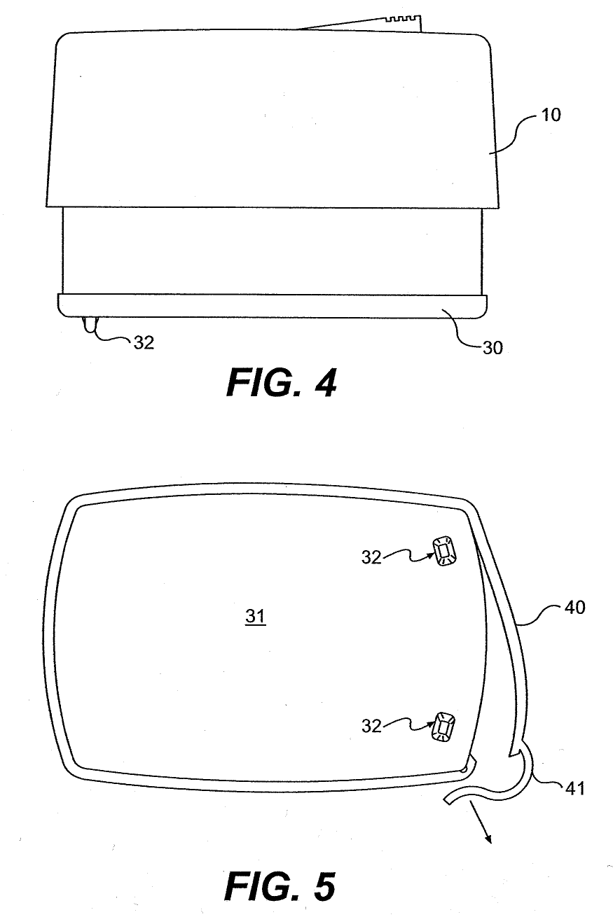

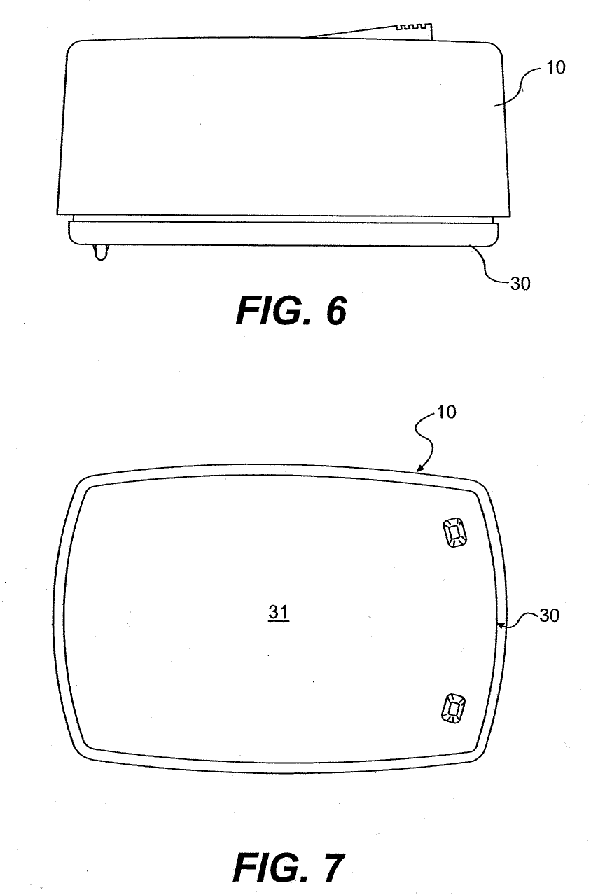

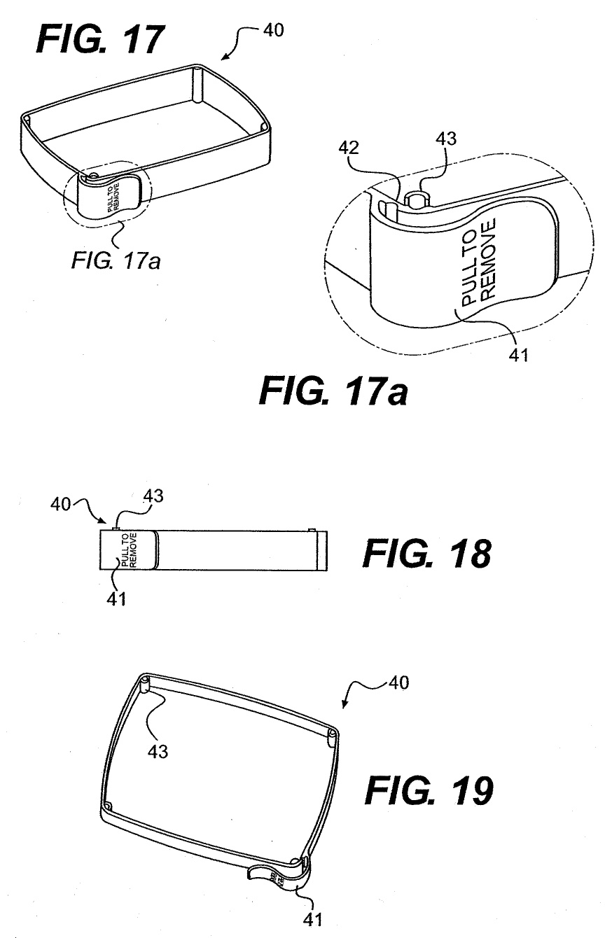

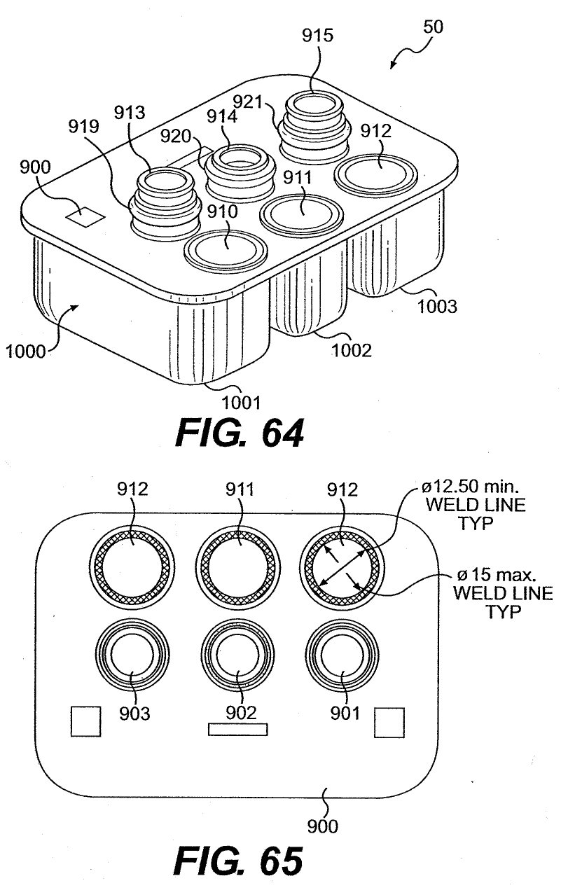

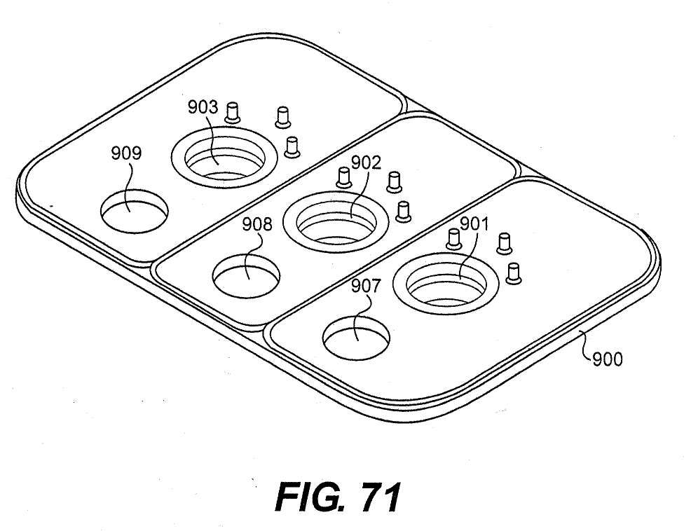

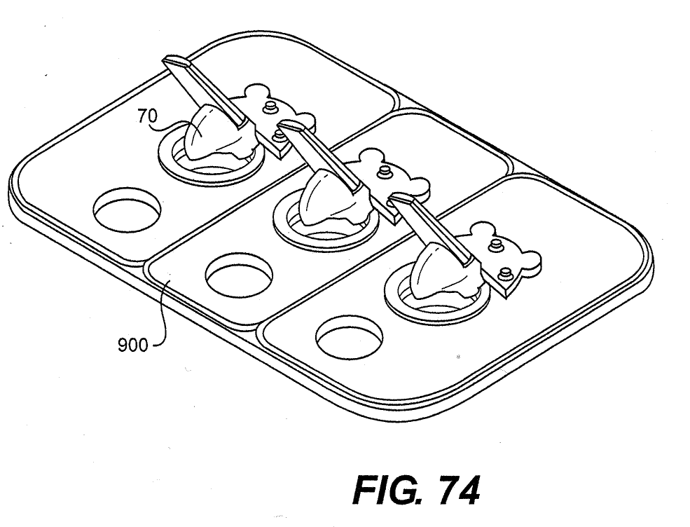

With reference to FIGS. 17-19, the removable tab 40 functions as a safety lock in that while it is installed on the fuel cell 1 it prevents activation of the fuel cell 1, i.e., it functions to prevent the cover 10 from moving relative to the base 30 which, in turn, ensures that the liquids stored in the bladder system 50 are prevented from passing into the chambers associated with the anode 301 and cathode 401. The removable tab 40 has a pull tab portion 41 which can be gripped by a user's fingers such that when the portion 41 is pulled away from the fuel cell 1, the removable tab 40 is caused to break apart (see FIG. 5) at a predetermined weakened portion 42 (see FIG. 17a). Once broken and removed, the removable tab 40 can be discarded. The user can then move or squeeze the cover 10 and the base 30 towards each other (compare FIGS. 4 and 6) which activates the fuel cell 1 as follows: this movement causes compression of the bladder cells 1001-1003 of the bladder system 50 (see FIG. 64). This, in turn, causes the puncturing devices 70 (see FIGS. 74-76) to puncture the respective membrane seals 901-903 (see FIG. 71). Further movement of the cover 10 towards the base 30 causes further compression of the bladder cells 1001-1003 which causes or forces the liquids stored in the bladder system 50 to pass into the chambers associated with the anode 301 and cathode 401. Once this movement of the cover 10 and the base 30 reaches a maximum point, the cover 10 and the base 30 become locked together (via members 24-27, 39, and 528-535) and the fuel cell 1 is irreversibly activated. The locking of the cover 10 and the base 30 also prevents the user from opening the fuel cell 1 and provides a visual indication that the fuel cell 1 is in an activated mode.

As is apparent from FIGS. 17-19, the removable tab 40 has a strip-like configuration formed into a generally rectangular shape. Each corner of the tab 40 has a projection 43 which is e.g., generally circular, and which slidably engages with a correspondingly shaped recess 37 formed in the base 30 (see FIG. 16b) and is slid onto the base 30 prior to assembling together the cover 10 and the base 30. The projections 43 and the upper and lower edges of the tab 40 engage with edges/surfaces of the cover 10 and the base 30 and function to prevent movement of the cover 10 and the base 30 towards each other. By way of non-limiting example, the tab 40 can be a one-piece member injection molded member made of, e.g., LDPE (Low Density PolyEthylene).

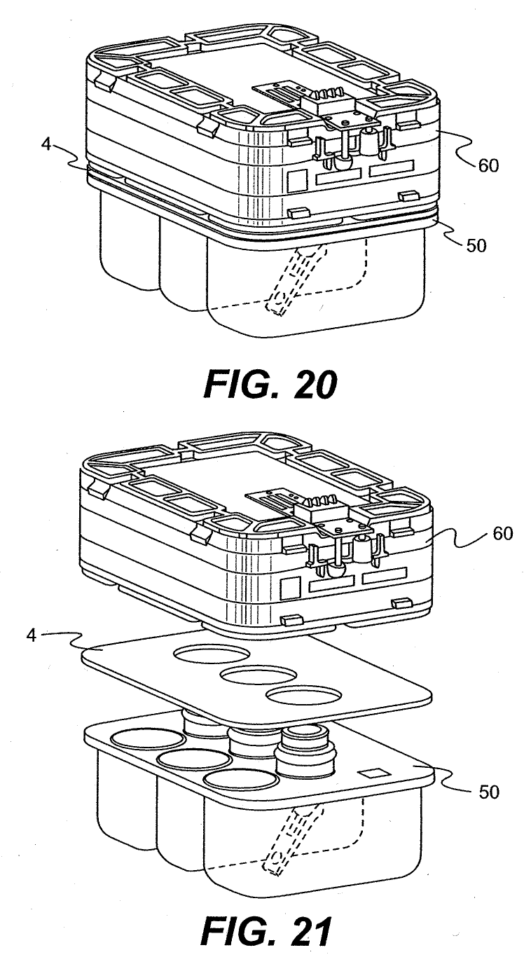

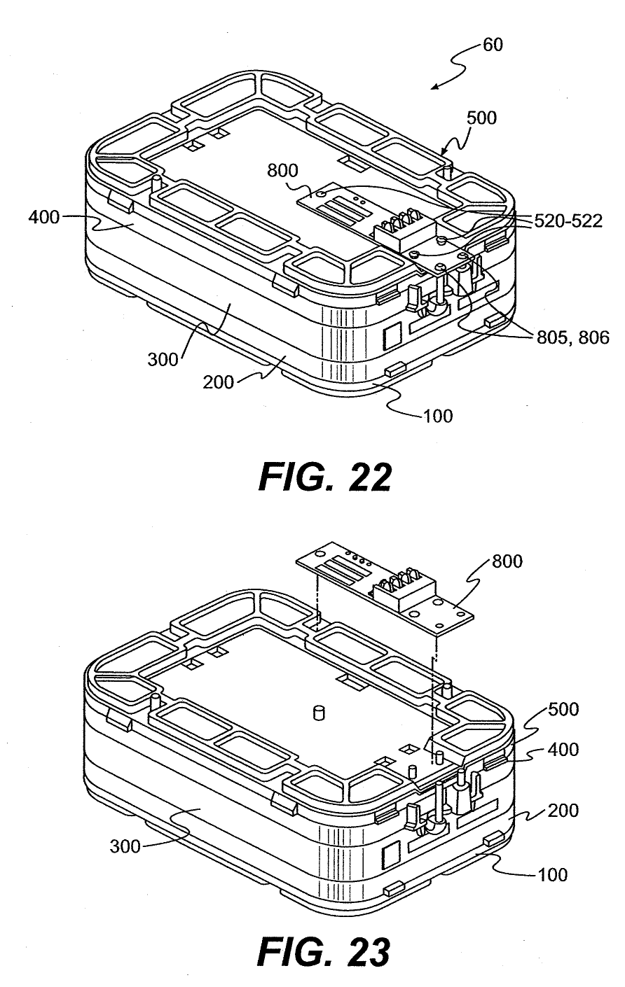

As can be seen in FIGS. 20 and 21, the fuel cell system arranged within the container formed by the cover 10 and base 30 includes a module 60 and a bladder system 50 which are connected together (with an absorbent member 4 sandwiched therebetween) prior to being installed within the cover 10 and the base 30. As can be seen in FIGS. 22-35, the module 60 is a sub-assembly made of six main components. These are the back or bottom frame 100, the extension frame 200, the anode frame 300, the cathode frame 400, the front or top frame 500, and the circuit board 800. After the frame members 100-500 are welded together, the circuit board 800 is staked to the front frame 500 by staking the three projections 520-522 (see FIG. 22). Then, the upper ends of the anode electrode 80 and the cathode electrode 90 are soldered to the contacts 805 and 806.

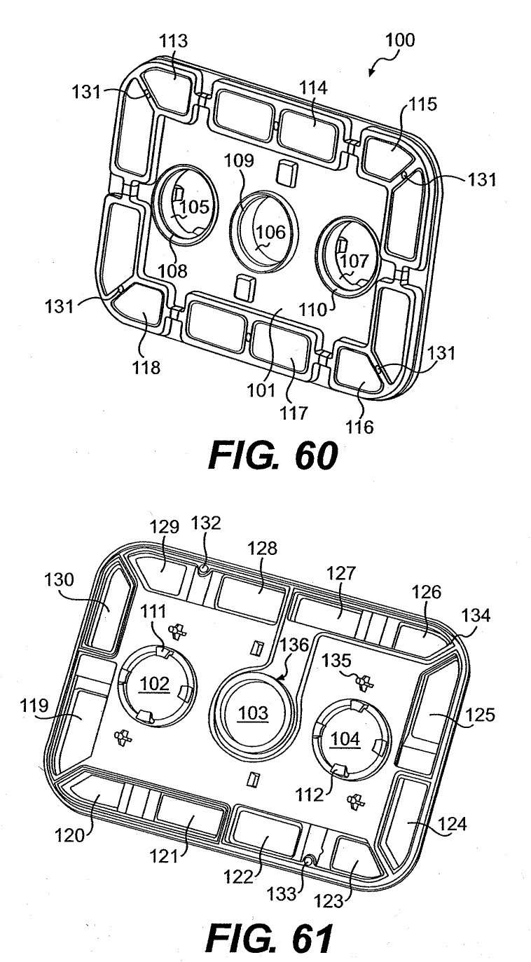

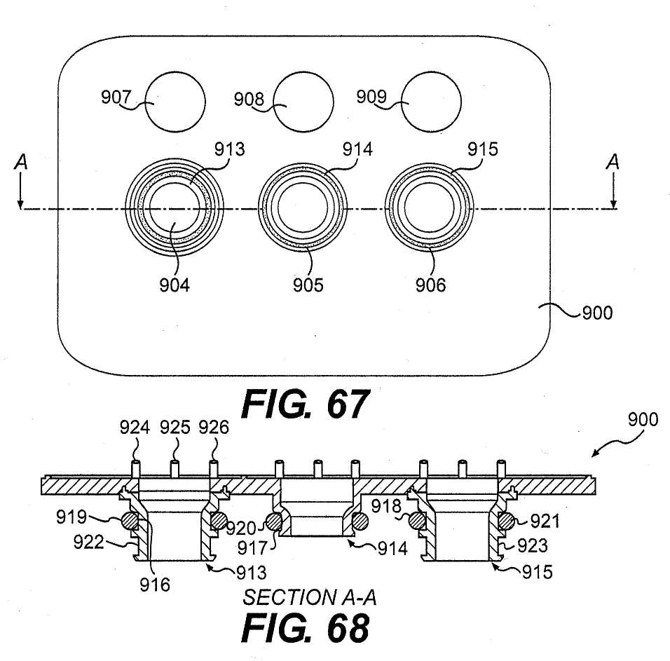

The module 60 and the bladder system 50 are assembled together to form the assembly shown in FIGS. 20-21 by first placing the absorbent member 4 over the nipple members 913-915 (see FIG. 64) until it rests on the upper surface of the bladder plate 900 (see FIG. 65). Then, the module 60 and the bladder system 50 are brought together until the o-rings 919-921 (see FIG. 64) make sealing contact with the surfaces 105-107 (see FIG. 60) and until the locking members 111 and 112 (see FIG. 61) become locked to the recesses 922 and 923 (see FIG. 68) of the nipple members 913 and 915 (see FIG. 67, 77, 78).

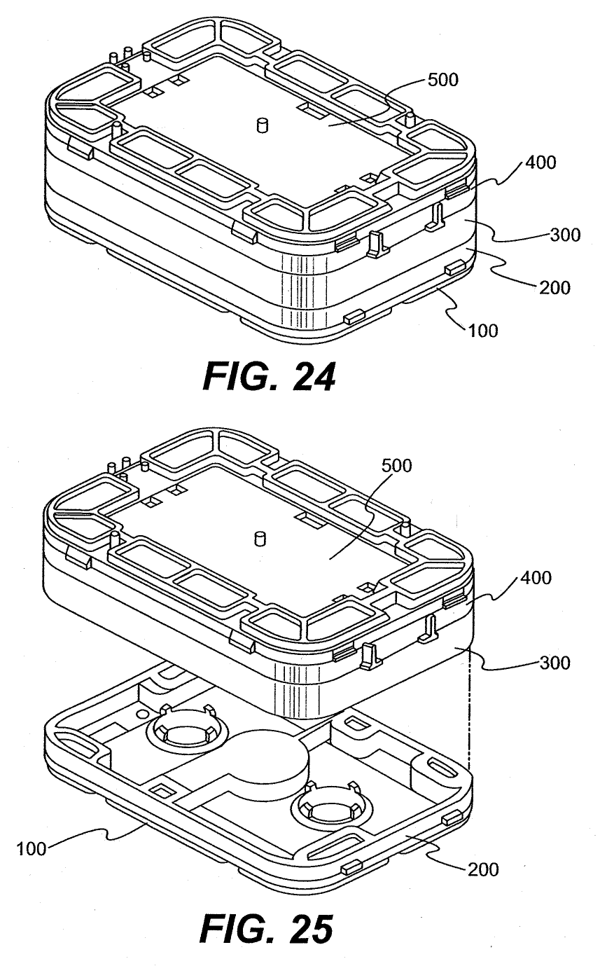

FIG. 24 shows a top rear side perspective view of the module 60 shown in FIG. 22 with the circuit board removed and shows the upper frame 500 secured to the cathode frame 400, the cathode frame 400 secured to the upper frame 500 and the anode frame 300, the anode frame 300 secured to the cathode frame 400 and the extension frame 200, the extension frame 200 secured to the anode frame 300 and the back frame 100. FIG. 25 shows an exploded view of FIG. 24 and shows an upper portion of the module 60, i.e., front frame 500, cathode frame 400 and anode frame 300, separated from a lower portion of the module 60, i.e., extension frame 200 and back frame 100.

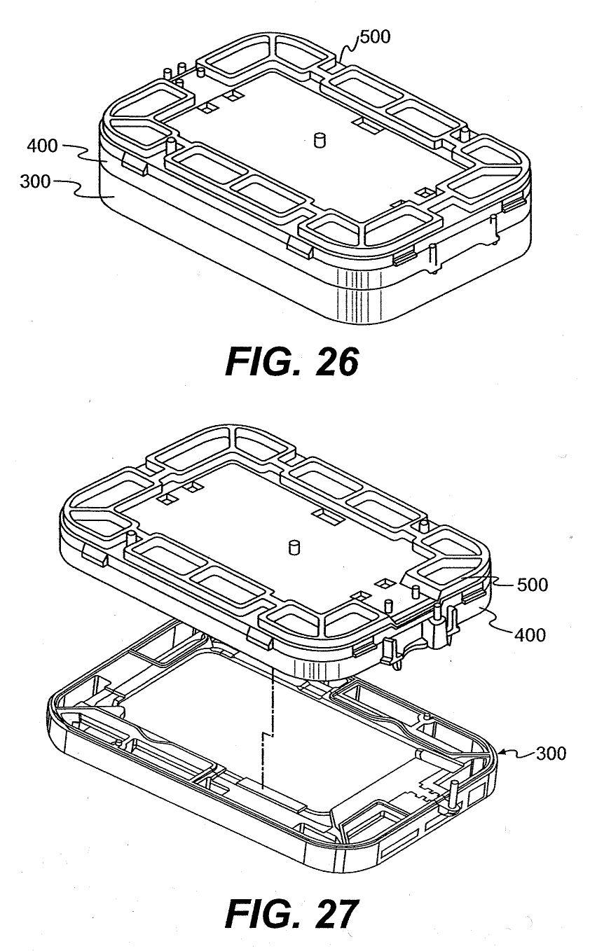

FIG. 26 shows a top rear side perspective view of the upper portion of the module 60 shown in FIG. 25 and illustrates the front frame 500, the cathode frame 400 and the anode frame 300 connected together. FIG. 27 shows an exploded view of FIG. 26 and shows the top frame 500 and the cathode frame 400 arranged above and separated from the anode frame 300.

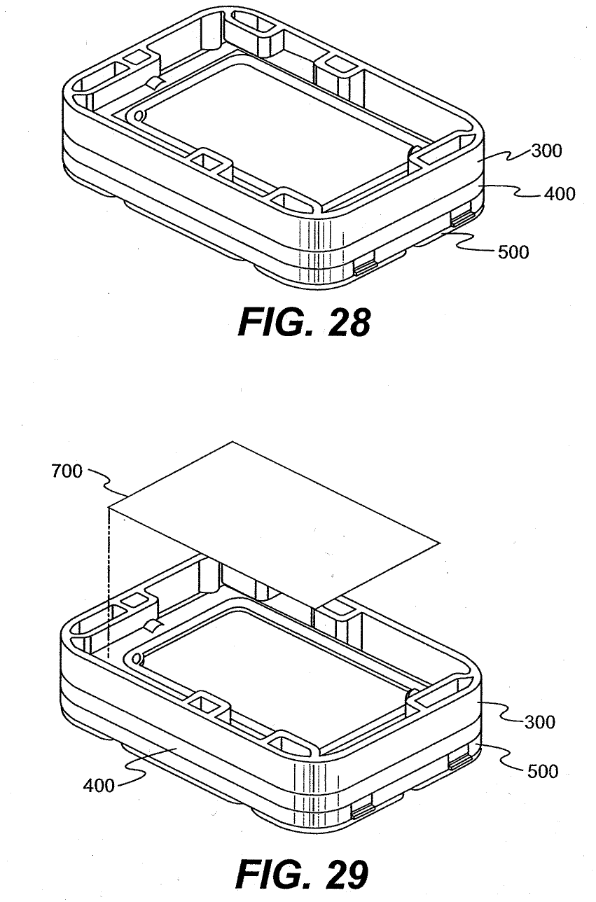

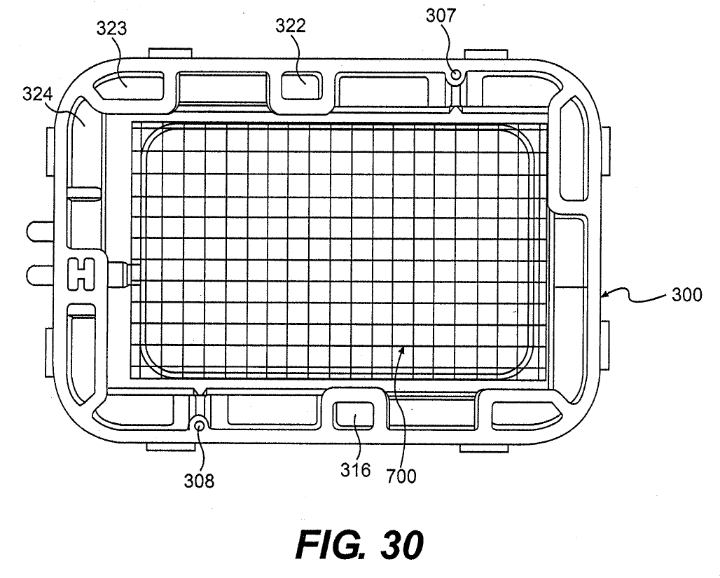

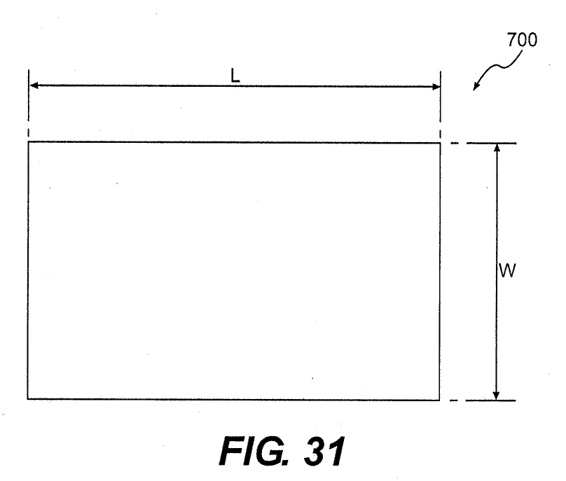

FIG. 28 shows a bottom rear side perspective view of the upper portion of the module 60 shown in FIG. 25 and illustrates the top frame 500, the cathode frame 400, and the anode frame 300. FIG. 29 shows the upper portion of FIG. 28 with an anode regulating mesh member 700 (in this regard, see, e.g., U.S. patent application Ser. No. 10/941,020) arranged above and separated from the top portion. FIG. 30 shows a top view of FIG. 29 with the anode regulating mesh member 70 secured to and within a bottom main recess of the anode frame via welding. FIG. 31 shows a top view of the anode regulating mesh member 700 used in the embodiment of FIG. 1.

The anode regulating mesh member 700 has the form of a wire mesh cloth and is sized to fit within the main bottom recess of the anode frame 300 (see FIGS. 29 and 30) and is therefore arranged between the extension frame 200 and the anode frame 300. As is shown in FIGS. 30 and 31, the mesh member 700 has a rectangular shape is secured to the main bottom recess of the anode frame 300. By way of non-limiting example, the mesh member 700 can be a plain weave wire mesh cloth which utilize generally square openings which have an opening size of about 50 μm. The wire diameter can be, e.g., about 0.04 mm. The mesh 700 can also be made of, e.g., stainless steel such as, e.g., 316L stainless steel. The mesh member 700 can also have an open area of, e.g., about 30%. Exemplary non-limiting length and width sizes for the mesh member 700 can be, e.g., a length L of about 60 mm and a width W of about 40 mm, or e.g., a length of about 65 mm and a width of about 40 mm.

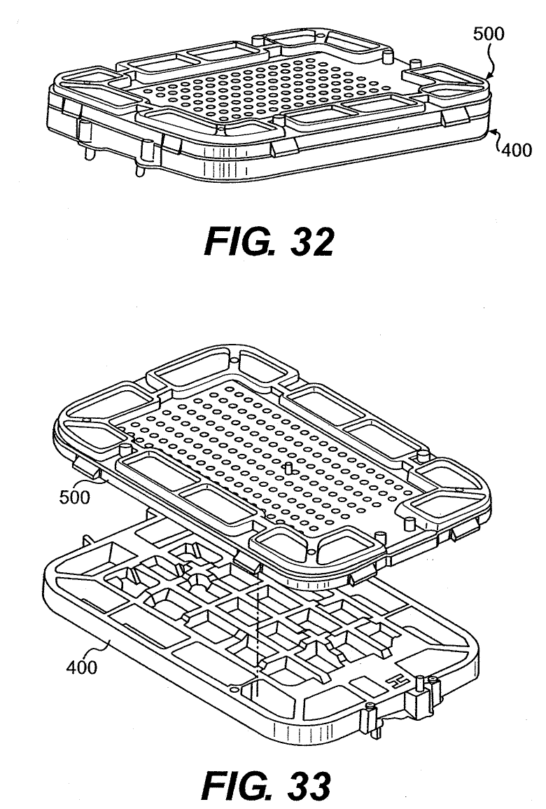

FIG. 32 shows a top rear side perspective view of an upper portion shown in FIG. 27 and including the top frame 500 and the cathode frame 400. FIG. 33 shows an exploded view of FIG. 32 and shows the top frame 500 arranged above and separated from the cathode frame 400.

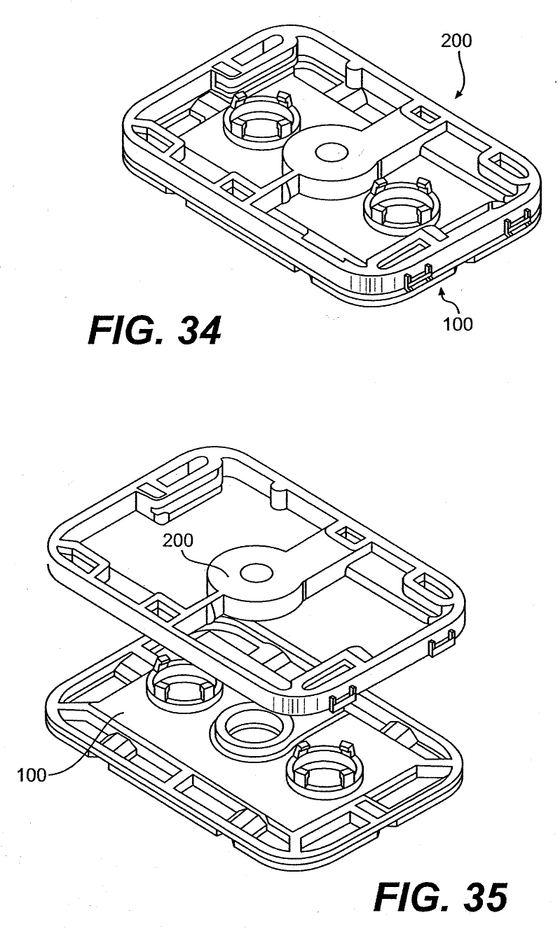

FIG. 34 shows a top side perspective view of the lower portion shown in FIG. 25 and including the extension frame 200 and the bottom frame 100. FIG. 35 shows an exploded view of FIG. 34 and shows the extension frame 200 arranged above and separated from the bottom frame 100.

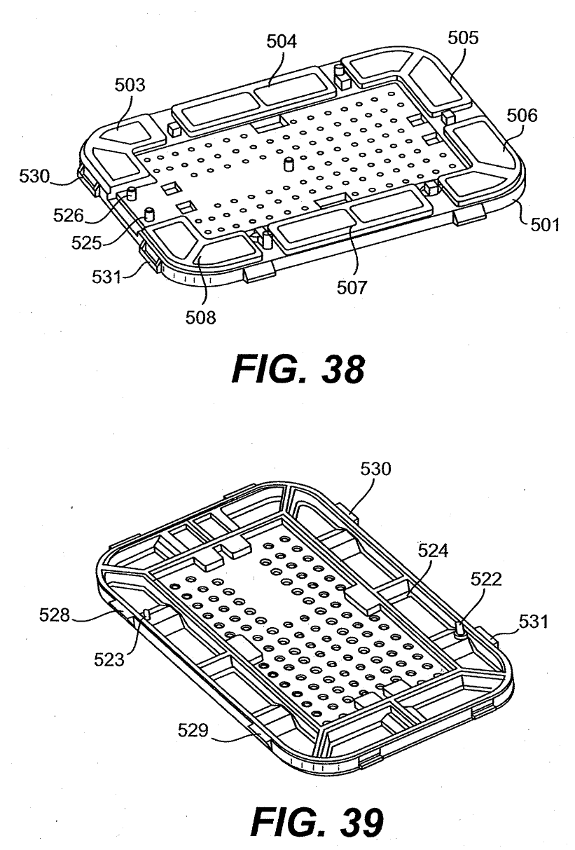

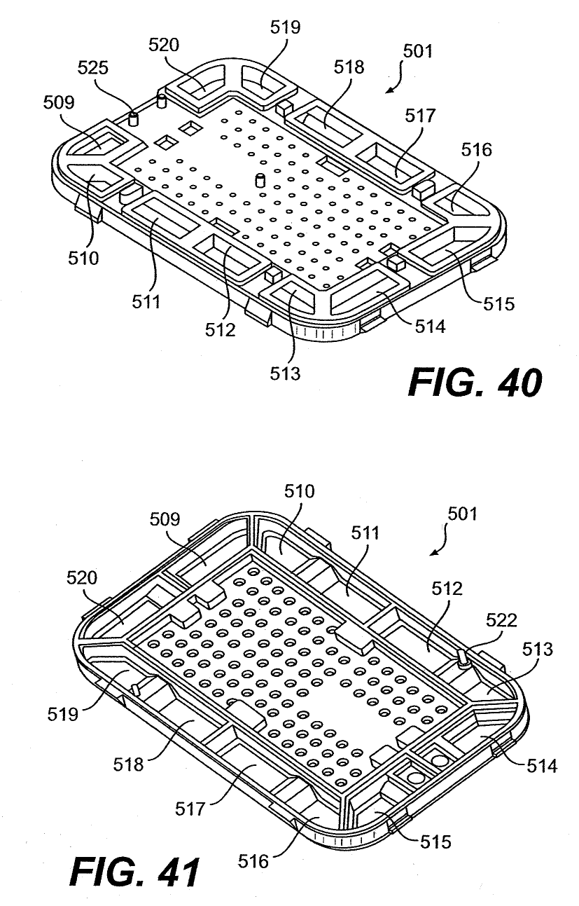

With reference to FIGS. 36-41, the top or front frame 500 is a sub-assembly made of three main components. One component is a one-piece synthetic resin frame member 501 having a generally rectangular shape and including a main perforated area 502. Another component comprises six one-piece vent membrane members 503-508 which are arranged to seal twelve perimeter openings 509-520 in the frame 501. The vent membrane members 503-508 can be of the type disclosed in U.S. patent application Ser. No. 10/758,080, the disclosure of which is hereby expressly incorporated by reference in its entirety. The vent membrane members 503-508 can be secured to the openings 509-520 by, e.g., welding their perimeter areas to the openings of the frame member 501. The frame 501 and the vent membrane members 503-508 are then subjected to overmolding in order to form the third component which has the form of rib structure 521. The rib structure 521 and the frame 501 trap the vent membrane members 503-508 and define twelve vent membrane perimeter passages in the front frame 500.

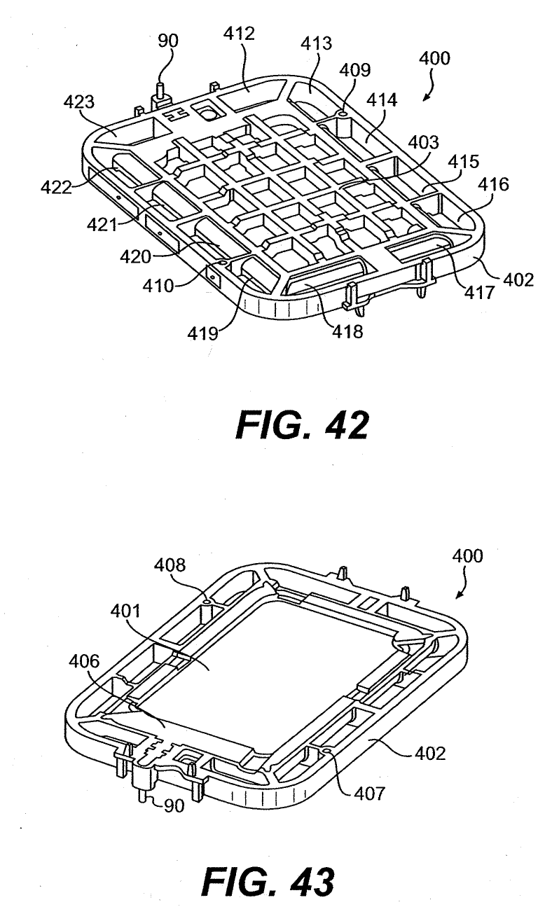

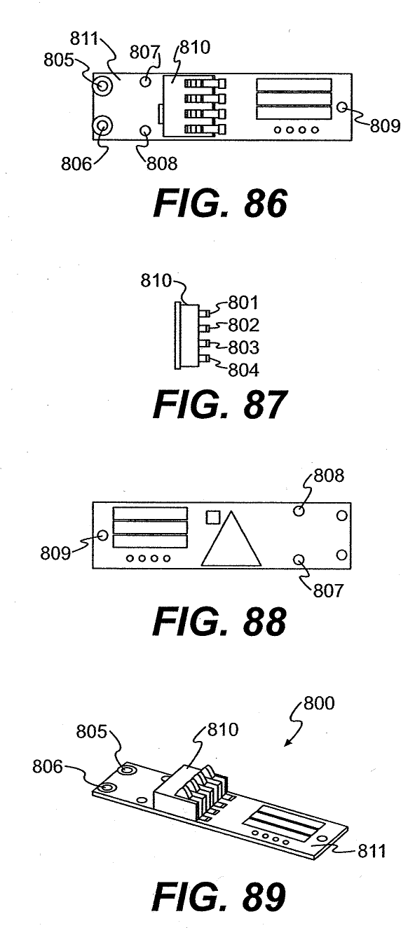

The front frame 500 also includes locating pins or projections 522 and 523 which are configured to extend into correspondingly positioned locating recesses 409 and 410 of the cathode frame 400 (see FIG. 42) and a patterned securing rib 524 which will form a welding seam for sealingly connecting together the front frame 500 and the cathode frame 400. The securing rib 524 has the form of a continuous projection which defines eight enclosed perimeter areas. These areas will receive fluids from the bladder system 50 after the fluids pass through the perimeter openings of the cathode frame 400. The front frame 500 also includes three circuit board connecting and positioning projections 525-527 which are configured to extend into three recesses 807-809 of the circuit board 800 (see FIGS. 86-88). The top frame 500 also utilizes oppositely arranged guide projections 532-535 which are sized and configured to slidably engage with and lock to correspondingly positioned recesses within lock members 39 of the base member 30 (see FIG. 15). Four oppositely arranged projections 528-531 are configured to lock to the four lock members 24-27 of the inner plate 20 (see FIG. 11). The material for the frame member 501 can be, e.g., an ABS copolymer. Exemplary non-limiting length and width sizes for the front or top frame 500 can be, e.g., a length of about 80 mm and a width of about 55 mm.

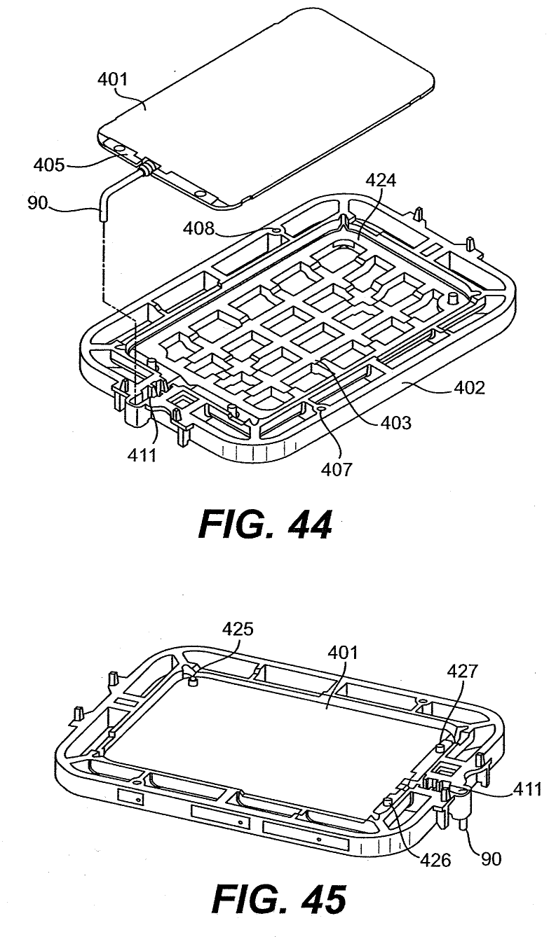

With reference to FIGS. 42-47, the cathode frame 400 is a sub-assembly made of five main components. One component is a one-piece synthetic resin frame member 402 having a generally rectangular shape and a main opening grid area 403. Another component is a cathode member 401 which is described in detail below. Still other components include a cathode pin 90 connected to a current collector 405 which is electrically connected to the cathode 401 (see FIG. 44). The cathode 401 is secured to a main lower recess 404 of the cathode frame 402 using an encapsulating resin material via, e.g., an over-molding or insert molding process, which forms another component 406 of the anode frame assembly 400. In this regard, U.S. patent application Ser. No. 11/452,199 may, for example, be referred to.

The cathode frame assembly 400 also includes locating recesses 407 and 408 which are configured to receive therein correspondingly positioned locating pins 309 and 310 of the anode frame 300 (see FIG. 50), as well as locating recesses 409 and 410 which are configured to receive therein correspondingly positioned locating pins 522 and 523 of the top frame 500 (see FIG. 37). Additionally, the cathode frame 400 also includes a cathode electrode recess 411 which is sized and configured to receive therein the cathode electrode 90, as well as a main recess 424 sized and configured to receive therein the cathode 401 (see FIGS. 44 and 45), and which receives therein a portion of the encapsulating material in order to securely retain the cathode electrode 90 and the cathode 401. The cathode frame assembly 400 also includes twelve perimeter openings 412-423 which allow for the passage of a portion of the contents of the bladder system 50. Projections 425-427 ensure that the cathode 401 is properly positioned in the recess 424 of the cathode frame 402. The material for the cathode frame member 401 can be, e.g., an ABS copolymer. Exemplary non-limiting length and width sizes for the cathode frame 400 can be, e.g., a length of about 80 mm and a width of about 55 mm.

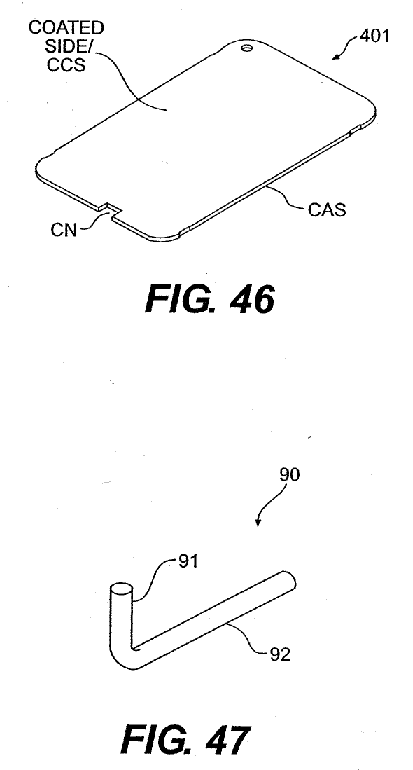

With reference to FIG. 46, the cathode 401 has the form of a generally rectangular plate and is sized to fit within the main lower recess of the cathode frame 402. The cathode 401 has an upper or coated side CCS and a lower active side CAS. A notch CN is arranged on one edge of the cathode 401. The notch CN provides a location for connecting the second leg 92 of the cathode pin 90 (see FIG. 47) to a current collector 405 which is electrically connected to the cathode 401. As is shown in FIGS. 44 and 45, the cathode 401 is secured to the main lower recess 424 of the cathode frame 402 using an encapsulating resin material 406 via, e.g., an over-molding or insert molding process. To ensure proper positioning of the cathode 401 within the cathode frame 402, the cathode 401 has locating openings which receive therein one or more locating pins 425-427 integrally formed on the cathode frame 402. The locating pin(s) 425-427 can be staked or peened over after the cathode 401 is installed in the cathode frame 402 in order to secure it to the frame 402 prior to the over-molding step. By way of non-limiting example, the locating openings can be circular and have a diameter of about 2 mm. The generally uniform thickness of the cathode 401 can be, e.g., about 1 mm. The cathode 401 also preferably utilizes rounded corners which correspond in shape to the rounded corners of the main lower recess of the cathode frame 402 and can have a radius of about mm. Exemplary non-limiting length and width sizes for the cathode 401 can be, e.g., a length of about 60 mm and a width of about 35 mm.

The cathode pin 90 is a conductor which conducts electricity between the cathode 401 and the circuit board 800. As is shown in FIG. 47, the cathode pin 90 is a bent solid generally circular wire having a first end or leg 91 and a second end or leg 92. The first end 91 is structured and arranged to be solder connected to the positive contact 806 of the circuit board 800. The second end 92 is structured and arranged to be crimped and/or solder connected to a current collector 405 of the cathode 401. The cathode pin 90 is also fixed to the cathode frame 400 by encapsulating resin material as is shown in FIGS. 42-45. By way of non-limiting example, the cathode pin 90 may have a wire diameter of about 1 mm. The overall length of the first leg 91 may be about 7 mm and the overall length of the second leg 92 may be about 15 mm. The cathode pin 90 can also be made of, e.g., nickel.

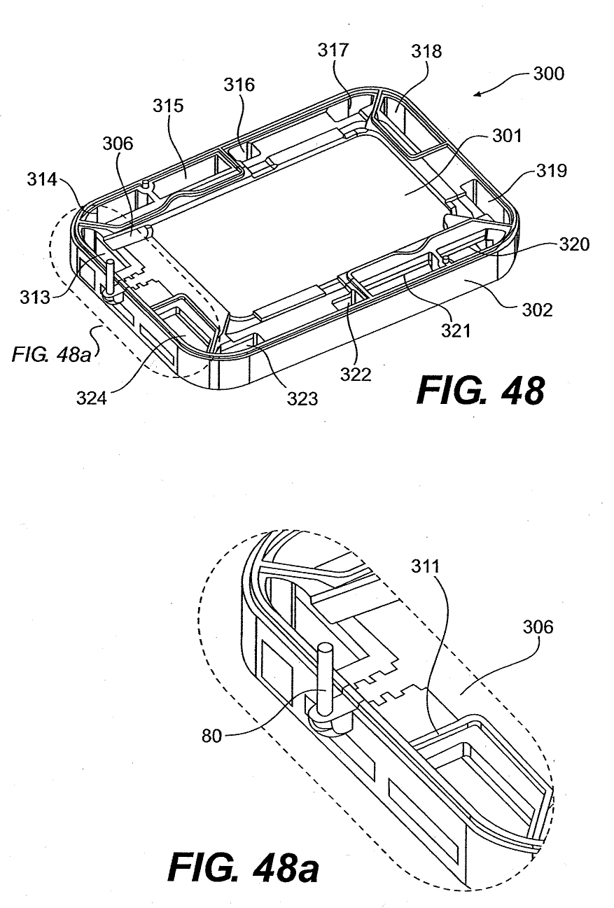

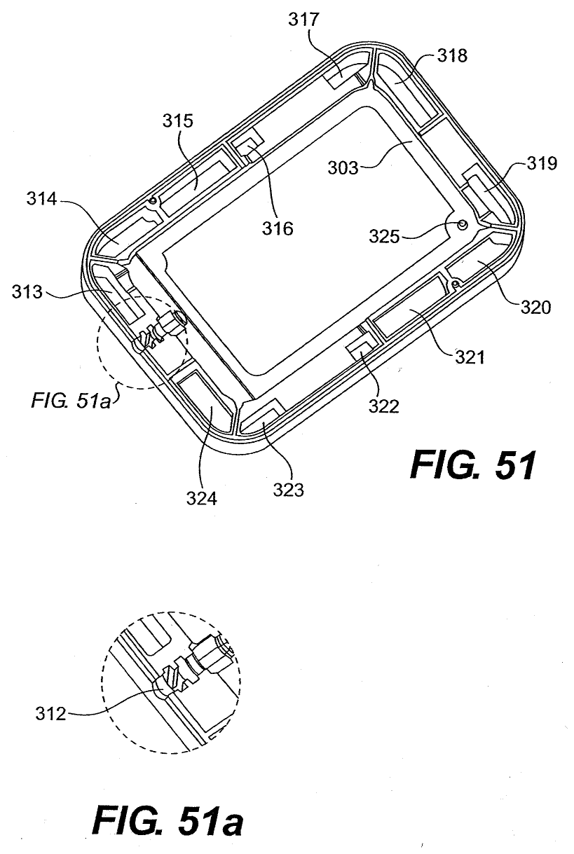

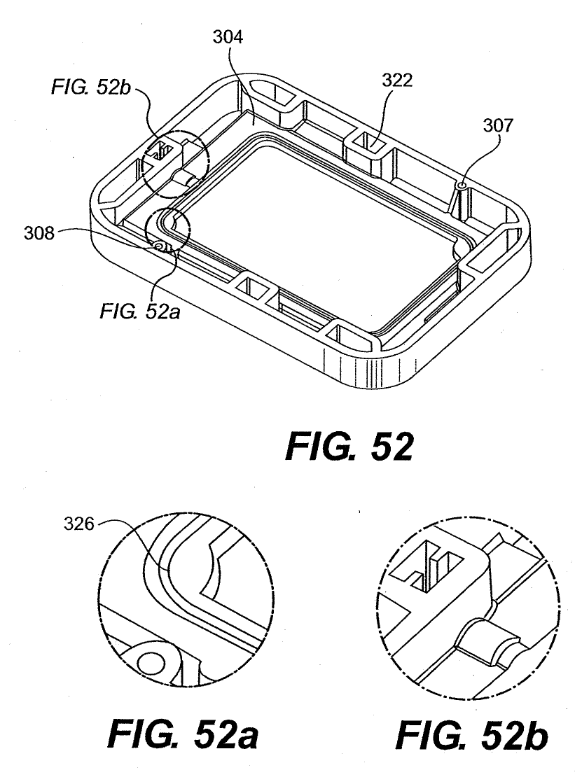

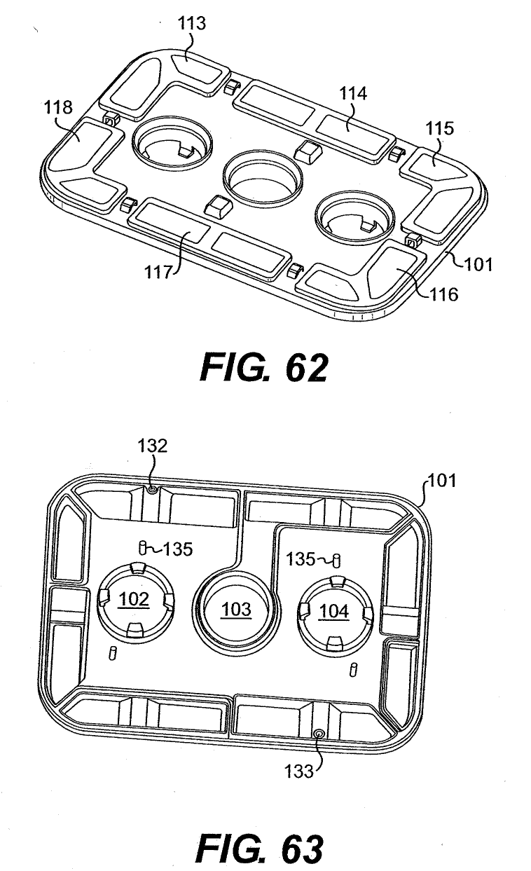

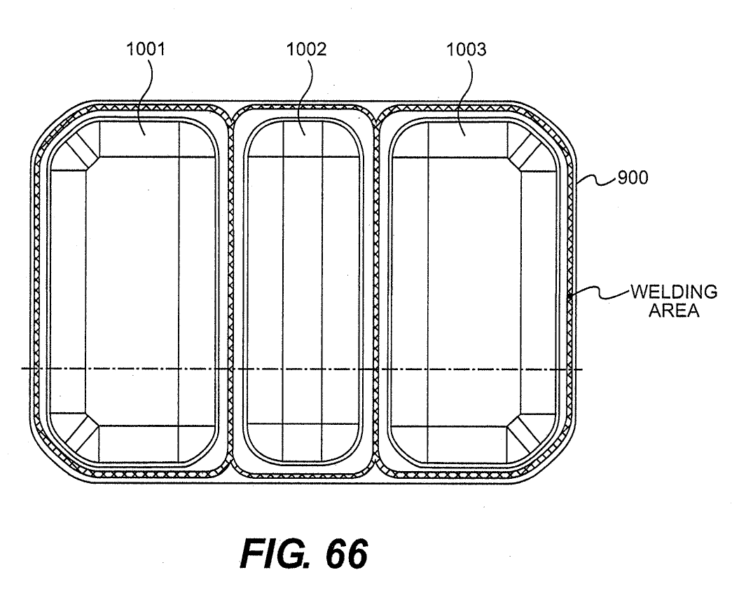

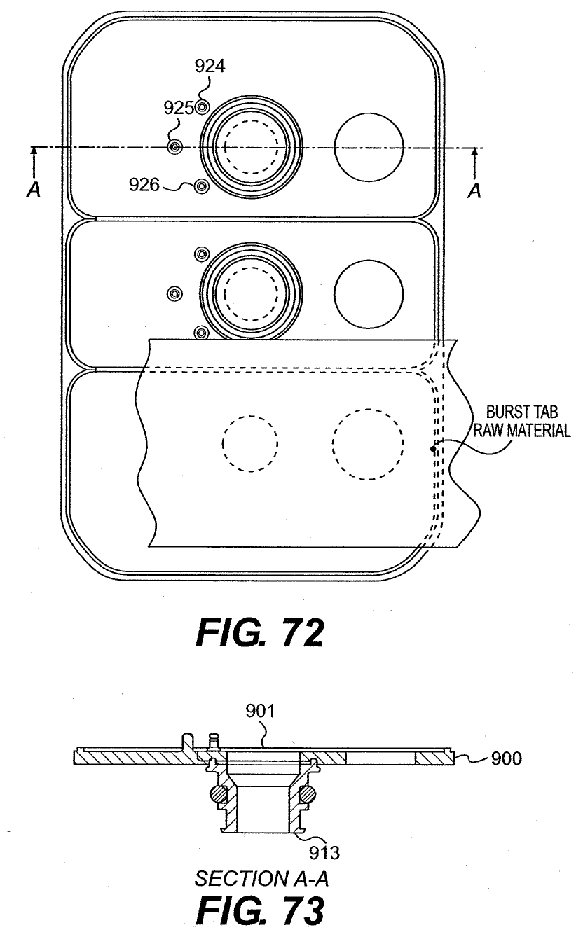

With reference to FIGS. 48-75, the anode frame 300 is a sub-assembly made of five main components. One component is a one-piece synthetic resin frame member 302 having a generally rectangular shape and a generally rectangular shaped upper recess 303 (see FIG. 51) and a generally rectangular shaped lower recess 304 (see FIG. 52). The open area of the recess 304 is structured and arranged to receive a portion of the contents of the two chambers 1001 and 1003 (see FIG. 66). Another component is an anode member 301 which is described in detail below. Still other components include an anode pin 80 to a current collector 305 which is electrically connected to the anode 301. The anode 301 is secured to the main upper recess 303 of the anode frame 300 using an encapsulating resin material via, e.g., an over-molding or insert molding process, which forms another component 306 of the anode frame 300. In this regard, U.S. patent application Ser. No. 11/452,199 may, for example, be referred to.

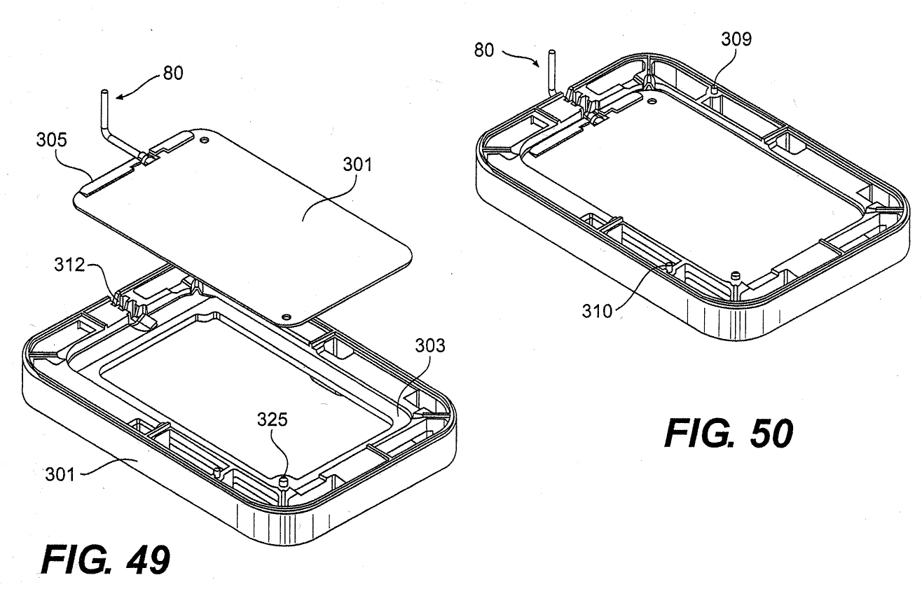

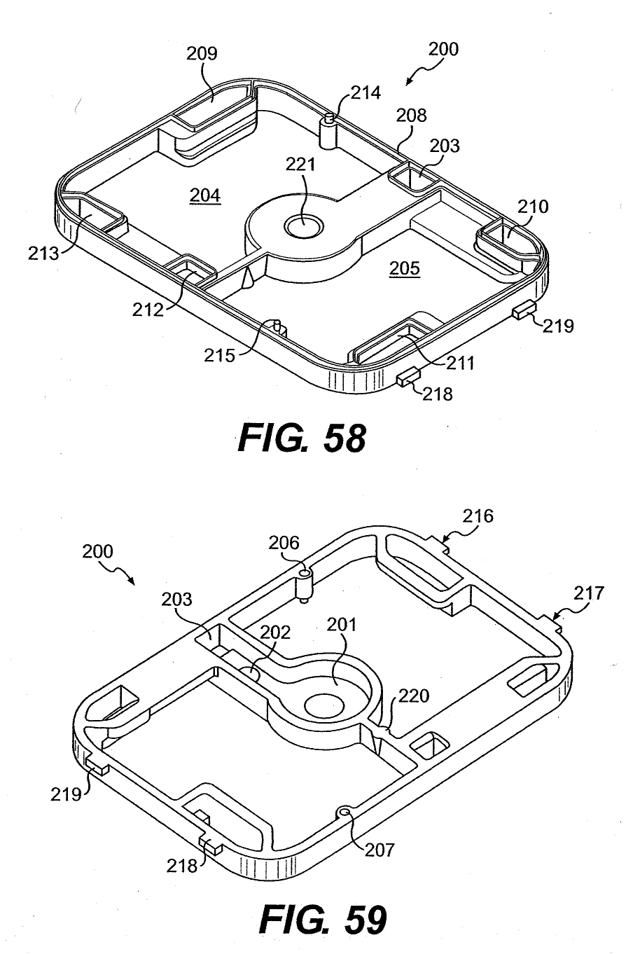

The anode frame assembly 300 also includes locating recesses 307 and 308 (see FIG. 52) which are configured to receive therein correspondingly positioned locating pins 214 and 215 of the extension frame 200 (see FIG. 58). Additionally, the anode frame assembly 300 also includes locating pins or projections 309 and 310 (see FIG. 50) which are configured to extend into correspondingly positioned locating recesses 407 and 408 of the cathode frame 400 (see FIG. 44) and a patterned securing rib 311 (see FIG. 48a) which will form a welding seam for sealingly connecting together the anode frame 300 and the cathode frame 400. Additionally, the anode frame assembly 300 includes an anode electrode recess 312 (see FIG. 49) which is sized and configured to receive therein the anode electrode 80 and also a portion of the encapsulating material 306 (see FIG. 48a) in order to securely retain the anode electrode 80. A projection 325 (see FIG. 49) ensures that the anode 301 is properly positioned within the anode frame 302. The anode frame assembly 300 also includes twelve perimeter openings 313-324 which allow for the passage of a portion of the contents of the bladder system 50. The material for the anode frame member 302 can be, e.g., an ABS copolymer. Exemplary non-limiting length and width sizes for the anode frame 300 can be, e.g., a length of about 80 mm and a width of about 55 mm.

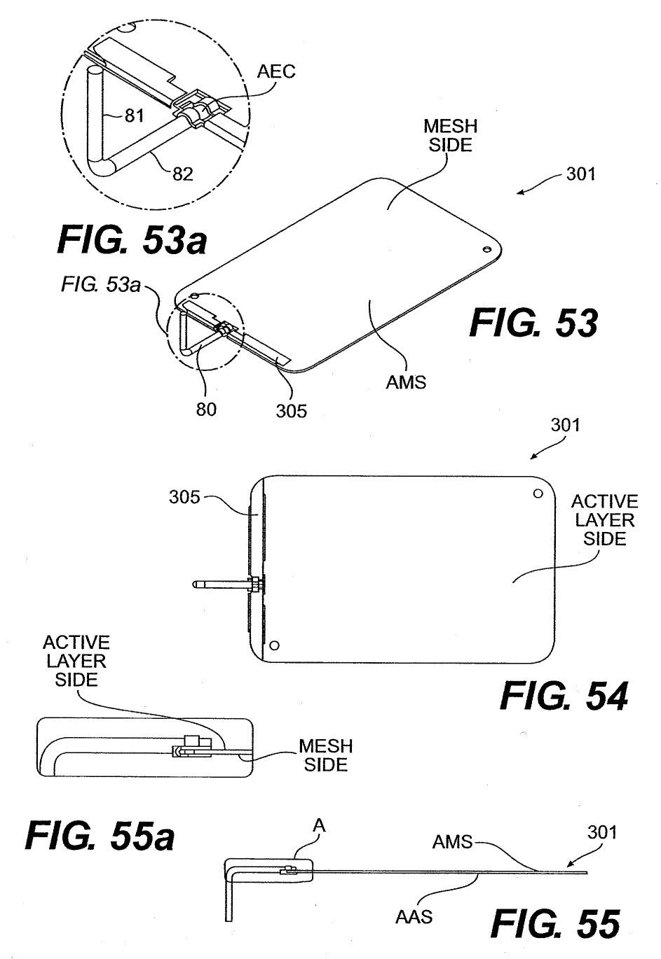

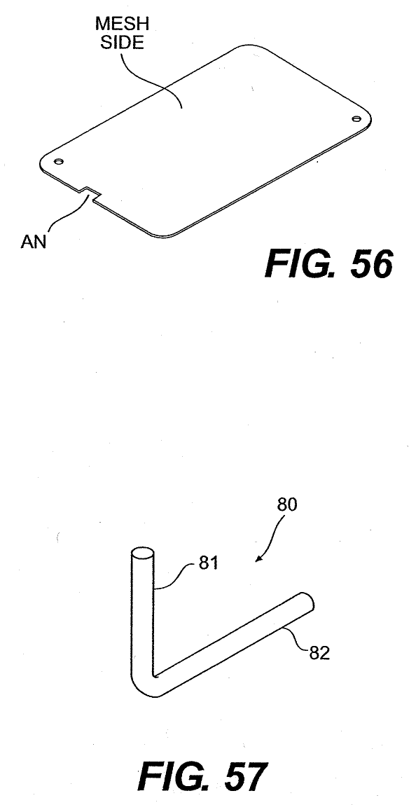

With reference to FIGS. 53-56, the anode 301 has the form of a generally rectangular plate and is sized to fit within the main upper recess 303 of the anode frame 302. The anode 301 has an upper or mesh side AMS and a lower active layer side AAS. A notch AN is arranged on one edge of the anode 301 (see FIG. 56). The notch AN provides a location for connecting via connection AEC (e.g., via a crimp and/or soldering connection) the second leg 82 of the anode pin 80 to a current collector 305 which is electrically connected to the anode 301. As is shown in FIG. 48-50, the anode 301 is secured to the main upper recess of the anode frame 302 using an encapsulating resin material 306 via, e.g., an over-molding or insert molding process. To ensure proper positioning of the anode 301 within the anode frame 302, the anode 301 has two corner locating openings which receive therein one or more locating pins 325 integrally formed on the anode frame 302. The locating pin(s) 325 can be staked or peened over after the anode 301 is installed in the anode frame 302 in order to secure it to the frame 302 prior to the over-molding step. By way of non-limiting example, the locating openings can be circular and have a diameter of about 2 mm. The generally uniform thickness of the anode 301 can be, e.g., about 0.3 mm. The anode 301 also preferably utilizes rounded corners which correspond in shape to the rounded corners of the main upper recess 303 of the anode frame 302 and can have a radius of about 5 mm. Exemplary non-limiting length and width sizes for the anode 301 can be, e.g., a length of about 65 mm and a width of about 40 mm.

The anode pin 80 is a conductor which conducts electricity between the anode 301 and the circuit board 800. As is shown in FIG. 57, the anode pin 80 is a bent solid generally circular wire having a first end or leg 81 and a second end or leg 82. The first end 81 is structured and arranged to be solder connected to the negative contact 805 of the circuit board 800. The second end 82 is structured and arranged to be crimped and/or solder connected to a current collector 305 of the anode 301. The anode pin 80 is also fixed to the anode frame 302 by encapsulating resin material 306 as is shown in FIG. 48a. By way of non-limiting example, the anode pin 80 may have a wire diameter of about 1 mm. The overall length of the first leg 81 may be about 11 mm and the overall length of the second leg 82 may be about 15 mm. The anode pin 80 can also be made of, e.g., nickel.

With reference to FIGS. 58 and 59, the extension frame 200 is a one-piece synthetic resin frame member having a generally rectangular shape and including a main circular recess 201 and a channel 202 allowing movement of fluid from the circular recess 201 (after entering into the recess 201 from the bladder 1002) to a perimeter opening 203. The recess 201 is structured and arranged to communicate with the chamber 1002 (see FIG. 66) via the opening 103 in the back frame assembly 100 (see FIG. 61). The extension frame 200 also includes main open areas 204 and 205 which are sized and configured to retain or contain a portion of the contents of the chambers 1001 and 1003 (see FIG. 66). The frame 200 also utilizes locating recesses 206 and 207 which are configured to receive correspondingly positioned locating pins 132 and 133 of the back frame 100 (see FIG. 61). The frame 200 also utilizes locating pins or projections 214 and 215 which are configured to extend into correspondingly positioned locating recesses 307 and 308 of the anode frame assembly 300 and a patterned securing rib 208 which will form a welding seam for sealingly connecting together the extension frame 200 and the anode frame 300 (see FIG. 52). A support rib 220 connects the member 221 forming the recess 201 to an opposite side of the frame 200. The extension frame 200 also includes five perimeter openings 209-213 which are sized and configured to receive a portion of the contents of the bladder system 50. The extension frame 200 further also utilizes oppositely arranged guide projections 216-219 which are sized and configured to slidably engage with correspondingly positioned recesses formed in members 39 of the base member 30 (see FIG. 16a). The material for the extension frame 200 can be, e.g., an ABS copolymer. Exemplary non-limiting length and width sizes for the extension frame 200 can be, e.g., a length of about 80 mm and a width of about 55 mm.

With reference to FIGS. 60-63, the bottom or back frame 100 is a sub-assembly made of three main components. One component is a one-piece synthetic resin frame member 101 having a generally rectangular shape and including three generally circular entrance openings 102-104. The openings 102-104 are structured and arranged to respectively communicate with the three chambers 1001-1003 of the bladder system 50 (see FIG. 66). In this regard, the openings 102-104 are sized and configured to respectively seal to the three nipple members 913-915 (see FIG. 64). The sealing occurs by sealing engagement between the o-rings 919-921 (see FIG. 64) and the circumferential sealing surfaces 105-107. Proper insertion of the o-rings 919-921 into the openings 102-104 is facilitated by three tapered surfaces 108-110 arranged at a lower end of the circular walls 105-107. A locking together of the openings 102 and 104 and the nipple members 913 and 915 occurs by engagement between locking projections 111 and 112 (see FIG. 61) and circular recesses 922 and 923 of the outer nipple members 913 and 915. The locking connection occurs automatically as the nipple members 913-915 move to a final position within the openings 102-104. This locking preferably occurs when the bladder system 50 is assembled to the module 60 (see FIGS. 20-21).

Another component of the bottom or back frame 100 comprises six one-piece vent membrane members 113-118 which are arranged to seal the twelve perimeter openings 119-130 in the frame member 101. The vent membrane members 113-118 can be of the type disclosed in U.S. patent application Ser. No. 10/758,080, the disclosure of which is hereby expressly incorporated by reference in its entirety. The vent membrane membranes 113-118 are secured to the openings 119-130 by having their perimeter areas welded to the openings in the frame member 101. The frame member 101 and the vent membrane members are then subjected to overmolding in order to form the third component which has the form of rib structure 131. The rib structure 131 and frame member 101 trap the vent membrane members 113-118 and define twelve vent membrane perimeter passages through the back frame assembly 100.

The back frame assembly 100 also includes locating pins or projections 132 and 133 which are configured to extend into correspondingly positioned locating recesses 206 and 207 of the extension frame 200 (see FIG. 59) and a patterned securing rib 134 which will form a welding seam for sealingly connecting together the back frame 100 and the extension frame 200. The back frame 100 also includes stand-off members 135 and a circumferential surface 136 sized and configured to extend into the main circular recess 201 of the extension frame 200. The material for the frame member 101 can be, e.g., an ABS copolymer. Exemplary non-limiting length and width sizes for the back frame 100 can be, e.g., a length of about 80 mm and a width of about 55 mm.

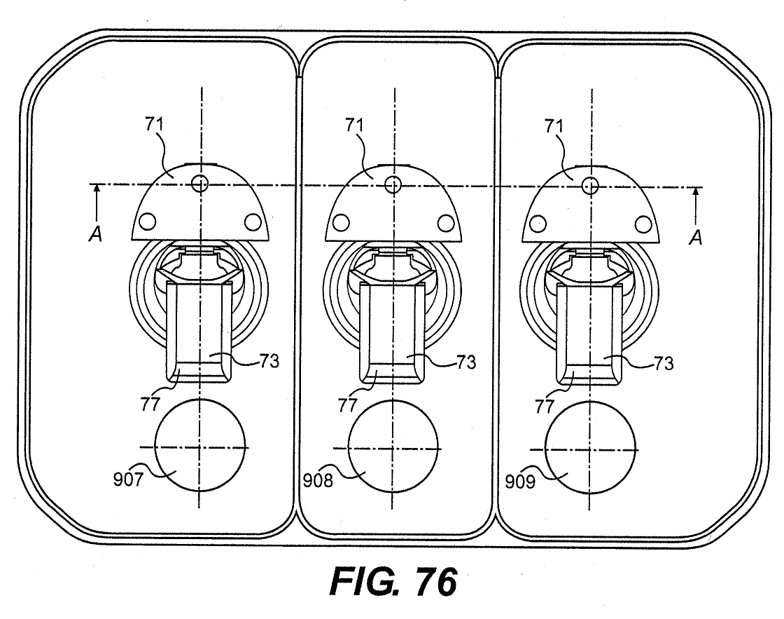

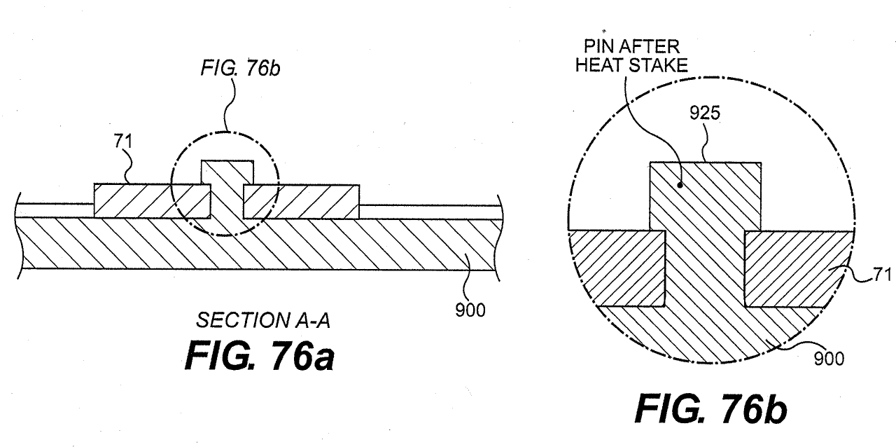

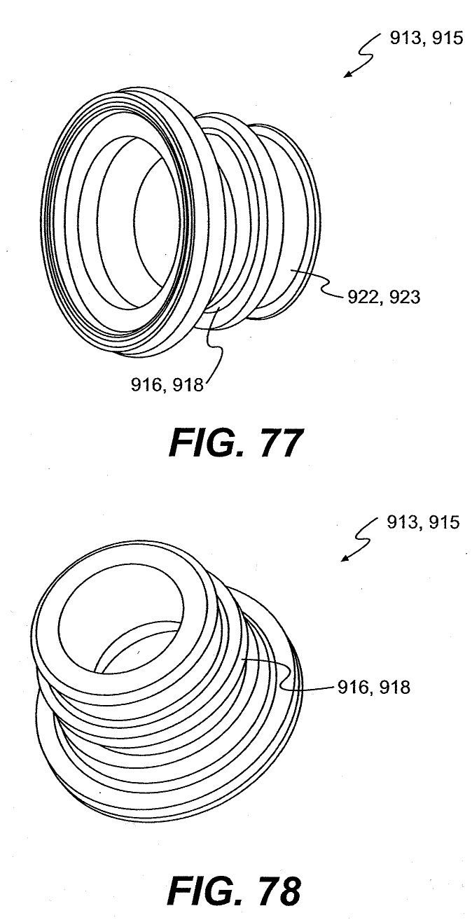

With reference to FIGS. 64-81, the bladder system 50 is a sub-assembly made of sixteen main components. These are a bladder member 1000, a bladder plate 900, three puncturing devices 70, two outer nipples 913 and 915, three o-rings 919-921, three exit opening membrane seals 901-903, and three fill opening membrane seals 910-912. Assembly of the bladder system 50 can occur as follows: after the puncturing devices 70 are fixed to the bladder plate 900 by staking the projections 922-924 (see FIGS. 76a and 76b), and after the seals 901-903 are formed (see FIGS. 71-73), the bladder member 1000 is seam welded to the bladder plate 900 (see FIG. 66). The o-rings 919-921 can be installed after the two nipples 913 and 915 are secured to the bladder plate 900. Finally, the chambers 1001-1003 are filed with the liquids used by the fuel cell 1 and the fill openings 904-906 are closed off with the three fill opening membrane seals 910-912 (see FIG. 65).

With reference to FIGS. 67 and 68, the bladder plate 900 is a one-piece synthetic resin member having a generally rectangular shape defined by three generally circular exit openings 904-906 which will respectively communicate with the three chambers 1001-1003 and three generally circular entrance openings 907-909 which will also respectively communicate with the three chambers 1001-1003. The three exit openings 904-906 are sealed-off with three circular-shaped membrane members 901-903 whose perimeters are seam welded (e.g., using ultrasonic welding) to the bottom surface of the bladder plate 900 (see FIGS. 71-73), and in particular, to perimeter areas of the openings 904-907. The three entrance openings 907-909 are sealed-off with three circular-shaped membrane members 910-912 whose perimeters are seam welded (e.g., using ultrasonic welding) to the top surface of the bladder plate 900 (see FIG. 65), and in particular, to perimeter areas of the openings 907-909. However, the entrance openings 907-909 are only sealed off after the bladder member 1000 and the bladder plate 900 are seam welded (see FIG. 66) via e.g., ultrasonic welding, to each other and after the bladder chambers 1001-1003 are filled with fluids via the openings 907-909. In this regard, the flange 1004 of the member 1000 is sized and shaped to generally correspond to the size and shape of the bladder plate 900 to which the flange 1004 is fixed. Three nipple members 913-915 extend out from the upper surface of the bladder plate 900. The nipple members 913-915 are respectively arranged to be in fluid communication the chambers 1001-1003. Each nipple member 913-915 includes a circular and/or circumferential recess 916-918 which is sized and configured to receive an o-ring 919-921. The o-rings 919-921 function to seal the nipple members 913-915 to the openings 102-104 in the bottom frame 100. The outer nipple members 913 and 915 have a greater axial length than the middle nipple member 914 and also include an additional circular and/or circumferential recess 922 and 923 which is sized to receive and lockingly engage with inwardly extending projections 111 and 112 (see FIG. 61). The projections 111 and 112 and recesses 922 and 923 function to non-removably lock the bladder system 50 to the module 60 thereby forming a fuel cell assembly (see FIG. 20) which can be placed into the cover 10 and base 30 during final assembly. Nipple members 913 and 915 are secured to the plate 900 via a projection and recess connection and by, e.g., welding. The invention contemplates forming the three nipple members 913-915 individually and then securing them (via e.g., ultrasonic welding) to the upper surface of the bladder plate 900. Preferably, the nipple members 913 and 915 are formed individually with the nipple member 914 and the bladder plate 900 being formed as a one-piece member. Then, the nipple members 913 and 915 are secured (via e.g., ultrasonic welding) to the upper surface of the bladder plate 900. Finally, the invention also contemplates forming the three nipple members 913-915 and the bladder plate 900 each as a one-piece members. The material for the bladder plate 900 can be, e.g., a polyolefin such as polyethylene. The material for the nipple members 913-915 if made separately can be, e.g., a polyolefin. Exemplary non-limiting length, length and width sizes for the bladder plate 900 can be, e.g., a length of about 80 mm, a width of about 55 mm. The body portion of the bladder plate 900 can have a thickness of, e.g., about 2 mm with, e.g., the center nipple member 914 extending above the upper surface by about 6 mm and with the outer nipple members 913 and 915 extending above the upper surface by about 10 mm.

As explained above, the three exit openings 904-906 are sealed-off with three circular-shaped membrane members 901-903 whose perimeters are seam welded (e.g., using ultrasonic welding) to the bottom surface of the bladder plate 900, and in particular, to perimeter areas of the openings 904-906. The width of the welded circular perimeter area can be, e.g., about 1 mm. The material for the membrane members 901-903 can be, e.g., a polyolefin such as HDPE (High Density PolyEthylene). The three entrance or fill openings 907-909 are sealed-off with three circular-shaped membrane members 910-912 whose perimeters are seam welded (e.g., using ultrasonic welding) to the top surface of the bladder plate 900, and in particular, to perimeter areas of the openings 907-909. The width of the welded circular perimeter area of the fill openings 907-909 can be about 1 mm. The bottom surface of the bladder plate 900 also includes three sets of three projections 924-926 which extend into the openings 74 of the puncturing devices 70 (see FIGS. 79 and 80). The projections 924-926 are preferably staked in order to fix or secure the puncturing devices 70 to the bladed plate 900 (see FIGS. 76-76b).

The o-rings 919-921 are one-piece members having a generally circular shape. As explained above, each o-ring is sized and configured to be tightly disposed within sealing recess 916-918 of each nipple member 913-915. The o-rings function to provide sealing between the nipple members 913-915 and the openings 102-104 of the bottom frame 100. Exemplary non-limiting diameter and thickness sizes for the o-rings 919-921 can be, e.g., an inside diameter of about 10 mm and a thickness of about 2 mm.

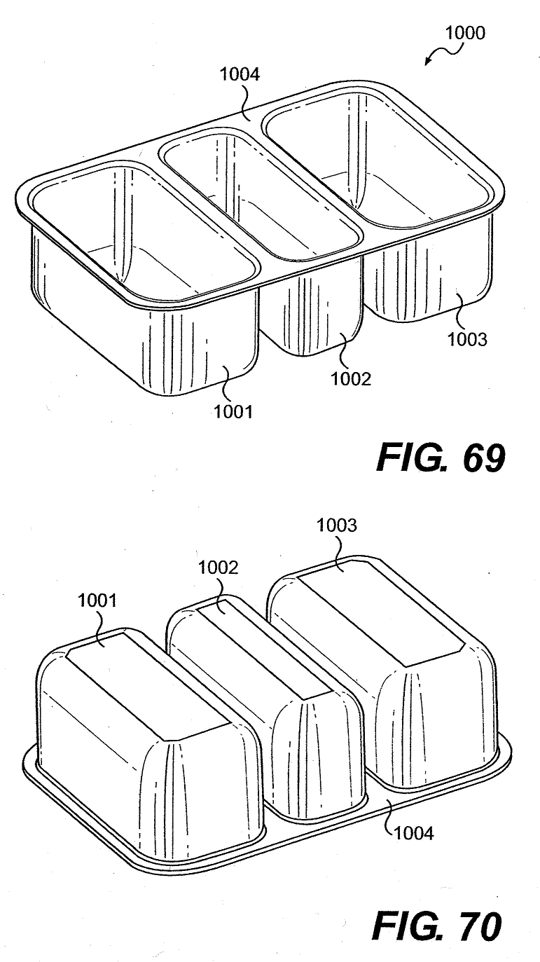

With reference to FIGS. 69 and 70, the bladder member 1000 is a one-piece synthetic resin member having a generally rectangular shape defined by three generally rectangular chambers 1001-1003 and a generally rectangular rim flange 1004, and can preferably be transparent or translucent. The flange 1004 is sized and shaped to generally correspond to the size and shape of the bladder plate 900 to which the flange 1004 will be fixed by, e.g., ultrasonic welding. The width of the welded perimeter areas can, for example, be about 1 mm (see FIG. 66). The two outer chambers 1001 and 1003 are essentially similar in side and shape and are sized and configured to store a liquid which will be transferred into the module 60 of the fuel cell 1 during activation of the fuel cell 1. The center chamber 1002 is smaller than the two outer chambers 1001 and 1003 and is sized and configured to store another liquid which will be transferred into the module 60 of the fuel cell 1 during activation of the fuel cell 1. The liquid stored in the center chamber 1002 will be transferred into the space between the anode 301 and the cathode 401 whereas the liquid stored in the outer chambers 1001 and 1003 will be transferred largely into the space between the bottom frame 100 and anode frame 300, and which is surrounded by the extension frame 200. The two larger chambers 1001 and 1003 can have a width of, for example, about 30 mm, a depth of about 25 mm and a length of about 50 mm. The center chamber 1002 can have a width of, for example, about 15 mm, a depth of about 20 mm and a length of about 50 mm. The wall of the bladder member 1000 forming the chambers 1001-1003 is flexible and is capable of being easily deflected, deformed, or wrinkled in order to allow the chambers 1001-1003 to reduce in volume during activation of the fuel cell 1. This reduction in volume forces the liquids in the chambers 1001-1003 to be transferred into the module as described in detail herein. The material for the bladder member 1000 can be, e.g., a polyolefin such as LLDPE (Linear Low Density PolyEthylene) or LDPE (Low Density PolyEthylene). Exemplary on-limiting length, width and height sizes for the bladder member 1000 can be, e.g., a length of about 80 mm, a width of about 55 mm and a height of about 25 mm. The flange portion 1004 of the bladder member 1000 can have a generally uniform thickness of, e.g., about 0.5 mm and a width of about 3 mm. The wall portion of the chambers 1001-1003 of the bladder member 1000 can have a generally uniform thickness of, e.g., about 0.3 mm.

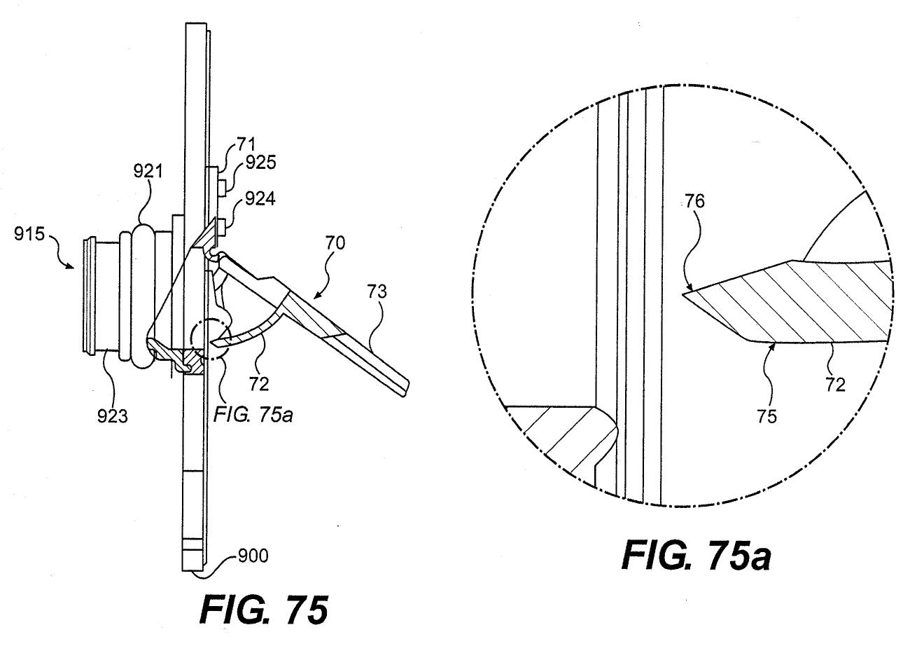

With reference to FIGS. 79 and 80, three puncturing devices 70 are utilized to puncture three membranes 901-903 covering the three openings 904-906 of the bladder plate 900. Each puncturing member 70 includes a mounting portion 71 which is configured to be fixed to a bottom surface of the bladder plate 900, a puncturing portion 72 movably or pivotally connected to the mounting portion via a living hinge, and a lever portion 73 capable of being moved when the cover 10 and the base 30 are moved towards each other. The mounting portion 71 includes openings 74, e.g., three openings, which are configured to receive projections or pins 924-926 projecting out from the bottom surface of the bladder plate 900 (see FIG. 68). The pins 924-926 and openings 74 are used to fixedly secure the mounting portion 71 to the bladder plate 900 (as is shown in FIGS. 74-76). The invention, however, contemplates connecting the mounting portion 71 to the bladder plate 900 using other mechanisms such as ultrasonic welding, bonding, etc. Furthermore, the invention also contemplates forming the puncturing devices 70 and the bladder plate 900 as a one-piece integral member. The puncturing portion 72 has the form of a ring-shape member utilizing an outwardly curved beak portion 75 whose free end has a single puncturing tooth 76 (see FIG. 75a). An opening is formed in the puncturing portion 72 in order to allow the contents of a respective bladder chamber 1001-1003 to exit the chambers 1001-1003, pass through the puncturing portions 72, and then out through the openings 904-906. The outwardly curved beak 75 functions to create by, e.g., tearing or shearing, a substantially circular opening in a respective membrane member 901-903 after each puncturing tooth 76 forms a puncture in a respective membrane 901-903. The lever portion 73 has a free end 77 which is configured to be engaged by a respective bottom bladder wall such that when the bladder chambers 1001-1003 are subjected to compressive forces (as will occur when the cover 10 and base 30 are moved towards each other), the bottom walls of the bladder chambers 1001-1003 with deform and cause the lever portions 73 to move or pivot about the living hinge. This, in turn, causes puncturing of the membranes 901-903. Further pivotal movement of the lever portions 73 causes a tearing or shearing of membranes 901-903, thereby forming substantially circular openings in the membranes 901-903. Since the user will typically activate the fuel cell 1 (which occurs when the cover 10 and base 30 are moved towards each other) in a matter of seconds, the initial puncturing, the tearing/shearing of the openings, and the transfer of substantially all of the fluids from the chambers 1001-1003 into the module 60 can occur in seconds. By way of non-limiting example, the puncturing devices 70 can be one-piece injection molded members made of e.g., an ABS copolymer.

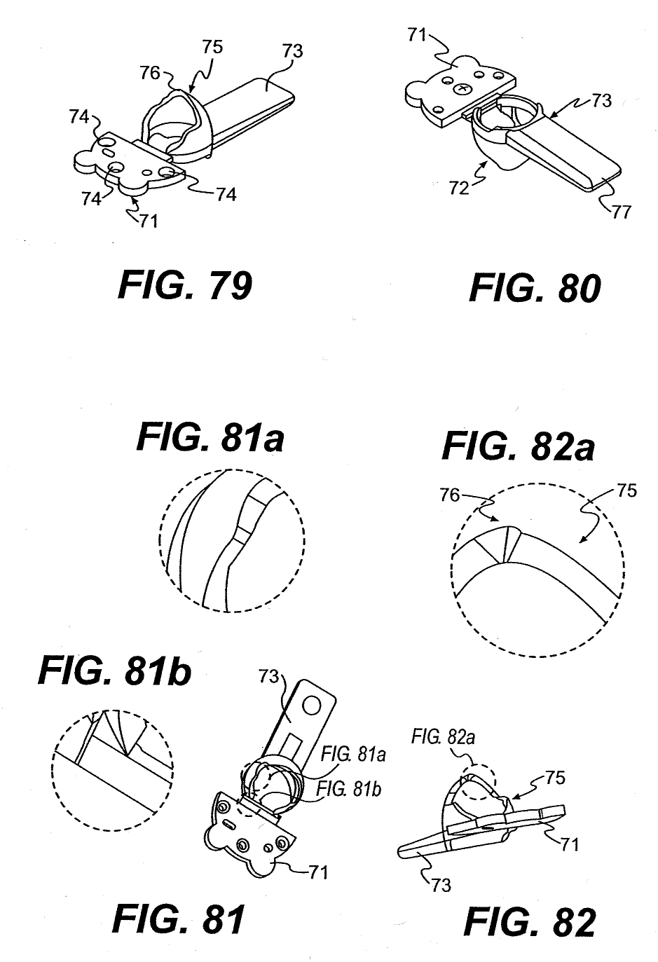

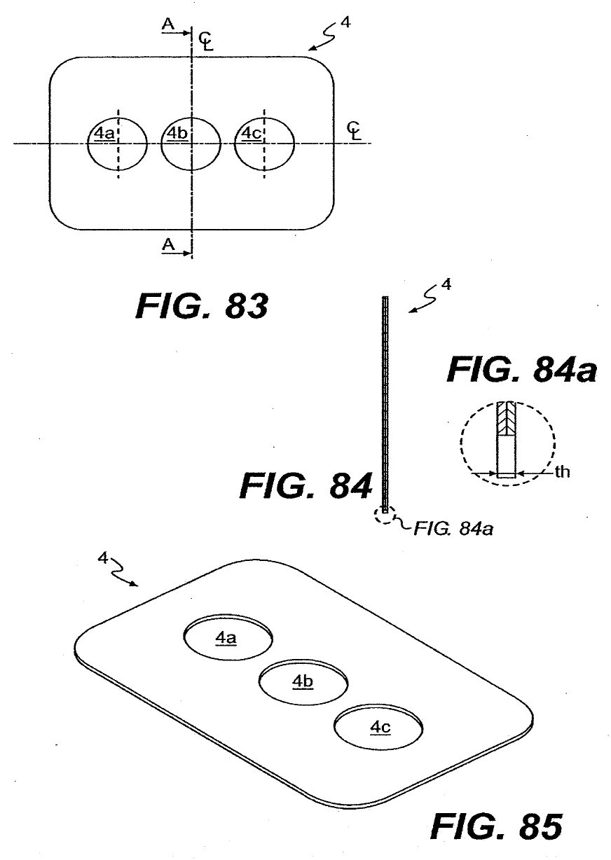

With reference to FIGS. 83-85, the absorbent member 4 is a multi-layered liquid absorbing member having a generally rectangular shape. The member 4 can, in particular, have two layers and is sized and configured to be loosely disposed between the top surface of the bladder plate 900 and a bottom surface of the bottom frame 100 (see FIG. 21). Three openings 4a-4c are sized to receive therein the three nipple members 913-915 (see FIG. 77). Any fluids which leak past the o-rings 919-921 of the nipple members 913-915 can be absorbed by the absorbent member 4. Exemplary non-limiting length, width and thickness sizes for the member 4 can be, e.g., a length of about 80 mm, a width of about 55 mm and a thickness “th” of about 0.8 mm.

With reference to FIGS. 86-89, the circuit member 800 has the form of a PCB and performs two main functions. One function is that it provides an electrical interface by ensuring that electricity is allowed to properly flow from the fuel cell 1 to a device receiving power from the fuel cell 1. In this regard, the circuit 800 has a contact support 810 arranged on a board member 811 and including contacts 801-804 which are each configured to make electrical contact with corresponding contacts in the connector of the wire connecting the fuel cell 1 to a device. Proper connection of the wire connector to the circuit contacts 801-804 is ensured by the connector opening 11 of the cover 10. The circuit 800 utilizes two main contacts 805 and 806 which utilize contact openings, and which function to electrically connect the circuit 800 to the anode 80 and the cathode 90 via an anode pin 80 and a cathode pin 90. The contact 805 is connected, preferably using a solder connection, to the anode pin 80 and represents the negative input contact of the circuit 800. The contact 806 is connected, preferably using a solder connection, to the cathode pin 90 and represents the positive input contact of the circuit 800. The circuit board 800 also includes three locating recesses 807-809 sized and configured to receive therein three locating and connecting projections 520-522 of the front or top frame 500. The other function of the circuit member 800 is to regulate, control and/or manage power transfer from the fuel cell 1 to a device. Non-limiting examples of such circuit devices can be found in U.S. patent application Ser. Nos. 11/476,561 and 11/476,568, the entire disclosures whereof are hereby expressly incorporated by reference herein. Exemplary non-limiting length and width sizes for the circuit member 800 can be, e.g., a length of about 40 mm and a width of about 10 mm.

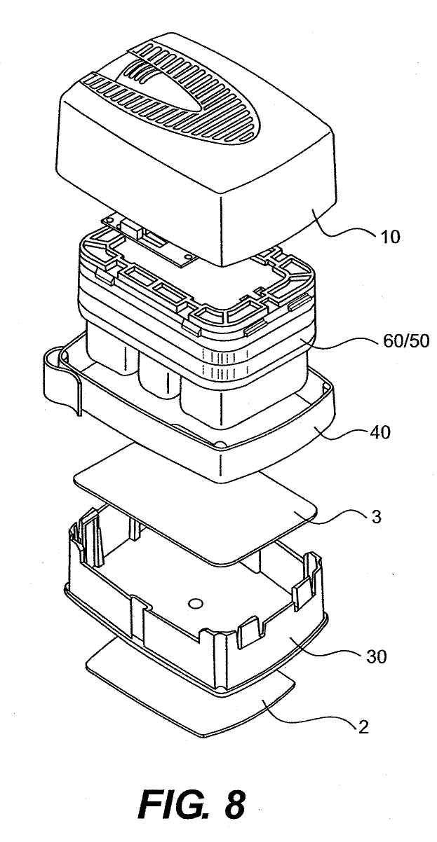

With reference to FIG. 8, the label 2 is a one-piece synthetic resin member having a generally rectangular shape. The label 2 is sized and configured to be adhesively attached to a bottom outer surface of the base member 30. The label 2 can include, among other things, instructions for how to use the fuel cell, information about its contents, and proper disposal instructions. Exemplary non-limiting length, width and thickness sizes for the label 2 can be, e.g., a length of about 70 mm and a width of about 50 mm. The bladder divider 3 is a one-piece member having a generally rectangular shape. The divider 3 is sized and configured to be loosely arranged between the bottom inner surface of the base member 30 and the bottom surfaces of the chambers 1001-1003 of the bladder member 1000. The divider 3 prevents the chambers 1001-1003 from directly contacting the bottom surface of the base 30 and prevents the chambers 1001-1003 from chafing.

It is noted that both the fuel cell, the cartridge and the transferring system are preferably disposable and are preferably made of light-weight materials. It should also be noted that the exemplary dimensions, values, sizes, volumes, etc., disclosed herein are not intended to be limiting and may vary to a large extent such as, e.g., from 50% less to 150% more. The majority of parts of the cartridge can be made of plastic (synthetic polymer) materials which are suitable for the fuel cell environment and which can withstand contact/exposure with fuel and electrolyte from a fuel cell and/or similar chemicals. Examples of non-limiting polymer materials include PVC, PP and polyurethane, etc.

By way of non-limiting example, all types of fuels, electrolytes and electrodes which are known for use with fuel cells and the like are contemplated for use by the present invention. Non-limiting examples of fuels, electrolytes and electrodes which are suitable for use in the present invention are disclosed in, e.g., U.S. Pat. No. 6,554,877 B2, mentioned above, U.S. Pat. No. 6,562,497 B2, U.S. Patent Application Publication Nos. 2002/0076602 A1, 2002/0142196 and 2003/0099876 A1, as well as in co-pending U.S. patent application Ser. No. 10/634,806. For example, all desirable liquid electrolytes (including those of very high and very low viscosity) may be utilized in each of the disclosed embodiments. Solid electrolytes may also possibly be utilized as well as ion exchange membranes. Matrix electrolytes can also be utilized such as, e.g., a porous matrix impregnated by a liquid electrolyte. Additionally, jelly-like electrolytes can also be utilized with any one or more of the disclosed embodiments. The invention also contemplates using hydrogen elimination systems in the fuel cell and/or cartridge. Non-limiting examples of fuel cell arrangements/systems with hydrogen removal (gas elimination) are disclosed in co-pending U.S. patent application Ser. No. 10/758,080, the entire disclosure of which is hereby expressly incorporated by reference.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of generating electrical power using a power system comprising at least one fuel cell unit having a fuel cell assembly and a fuel/electrolyte module arranged within a housing arrangement, the method comprising at least one of:
subjecting the housing arrangement to compression to cause at least a part of the contents of the fuel/electrolyte module to transfer from the fuel/electrolyte module to the fuel cell assembly;
gripping and squeezing the housing arrangement to cause at least a part of the contents of the fuel/electrolyte module to transfer from the fuel/electrolyte module to the fuel cell assembly; and
moving two portions of the housing arrangement relative to each other to cause at least a part of the contents of the fuel/electrolyte module to transfer from the fuel/electrolyte module to the fuel cell assembly.

2. The method of claim 1, further comprising, before the transfer, puncturing sealing members of the fuel/electrolyte module.

3. The method of claim 1, further comprising, immediately before the transfer, puncturing sealing members of each chamber of the fuel/electrolyte module.

4. The method of claim 1, further comprising removing a safety member acting to prevent the transfer.

5. The method of claim 1, wherein the fuel cell system is at least one of a stand-alone unit, a modular unit, and a portable unit.

6. The method of claim 1, wherein the fuel/electrolyte module comprises flexible material chambers.

7. The method of claim 1, wherein the fuel/electrolyte module comprises a plurality of separate sealed chambers and a plurality of puncturing members, each puncturing member being capable of puncturing a sealing member when the chambers experience a compressive force.

8. The method of claim 1, wherein the housing arrangement comprises first and second housing parts which move towards each other.

9. The method of claim 1, the at least one fuel cell unit comprises a system for delivering, feeding and/or conveying at least a part of the contents of each chamber of the fuel/electrolyte module to an appropriate chamber of the fuel cell assembly.

10. A method of generating electrical power using a power system comprising a fuel cell system including a housing arrangement, a fuel cell assembly comprising an anode and a cathode, a fuel/electrolyte module comprising a liquid fuel and/or a liquid electrolyte and/or components of the liquid fuel and/or the liquid electrolyte, and a device that, in a first position, prevents transfer of at least some of the contents of the fuel/electrolyte module from the module into the fuel cell assembly and that, in a second position, allows transfer of at least some of the contents of the fuel/electrolyte module from the module into the fuel cell assembly, wherein the fuel cell assembly and the fuel/electrolyte module are arranged within the housing arrangement, the method comprising at least one of:
subjecting the housing arrangement to compression to cause at least a part of the contents of the fuel/electrolyte module to transfer from the fuel/electrolyte module to the fuel cell assembly;
gripping and squeezing the housing arrangement to cause at least a part of the contents of the fuel/electrolyte module to transfer from the fuel/electrolyte module to the fuel cell assembly; and
moving two portions of the housing arrangement relative to each other to cause at least a part of the contents of the fuel/electrolyte module to transfer from the fuel/electrolyte module to the fuel cell assembly.

11. The method of claim 10, wherein the fuel cell system is at least one of a stand-alone unit, a modular unit, and a portable unit.

12. The method of claim 10, wherein the fuel/electrolyte module comprises flexible material chambers.

13. The method of claim 10, wherein the fuel/electrolyte module comprises a plurality of separate sealed chambers and a plurality of puncturing members, each puncturing member being capable of puncturing a sealing member when the chambers experience a compressive force.

14. The method of claim 10, wherein the housing arrangement comprises first and second housing parts which move towards each other.

15. The method of claim 10, further comprising a system for delivering, feeding and/or conveying at least a part of the contents of each chamber of the fuel/electrolyte module to an appropriate chamber of the fuel cell assembly.

16. A method of generating electrical power using a fuel cell system comprising a housing arrangement and a fuel/electrolyte module, the method comprising at least one of:
subjecting the housing arrangement to compression to cause at least a part of the contents of the fuel/electrolyte module to transfer from the fuel/electrolyte module to the fuel cell assembly;
gripping and squeezing the housing arrangement to cause at least a part of the contents of the fuel/electrolyte module to transfer from the fuel/electrolyte module to the fuel cell assembly; and
moving two portions of the housing arrangement relative to each other to cause at least a part of the contents of the fuel/electrolyte module to transfer from the fuel/electrolyte module to the fuel cell assembly.

17. The method of claim 16, wherein the fuel cell system comprises a fuel cell assembly comprising an anode and a cathode, wherein the fuel/electrolyte module comprises a liquid fuel and/or a liquid electrolyte and/or components of the liquid fuel and/or the liquid electrolyte, wherein the housing arrangement houses the fuel cell assembly and the fuel/electrolyte module, and further comprising a system for transferring at least a part of the contents of the fuel/electrolyte module into the fuel cell assembly.

18. The method of claim 17, wherein the contents is caused to be transferred by movement of one part of the housing arrangement relative to another part of the housing arrangement.

19. The method of claim 16, wherein the fuel cell system is at least one of a stand-alone unit, a modular unit, and a portable unit.

20. The method of claim 16, wherein the fuel cell system is a portable unit.

21. The method of claim 16, wherein the fuel/electrolyte module comprises a plurality of separate chambers.

22. The method of claim 21, wherein the separate chambers each have a sealed opening.

23. The method of claim 16, wherein the fuel/electrolyte module comprises at least two separate chambers.

24. The method of claim 23, wherein at least one of the at least two separate chambers comprises a fuel or a component thereof and at least one of the at least two separate chambers comprises an electrolyte or a component thereof.

25. The method of claim 16, wherein the fuel/electrolyte module comprises three separate chambers.

26. The method of claim 25, wherein the three chambers comprise a first chamber for holding a liquid fuel concentrate, a second chamber for holding a liquid for diluting the concentrate, and a third chamber for holding electrolyte.

27. The method of claim 26, wherein the first chamber comprises a liquid fuel concentrate which comprises at least one of a hydride compound and a borohydride compound.

28. The method of claim 26, wherein the first chamber comprises a liquid fuel concentrate which comprises a borohydride compound.

29. The method of claim 28, wherein the borohydride compound comprises at least one of NaBH₄, KBH₄, LiBH₄, NH₄BH₄, Be(BH₄)₂, Ca(BH₄)₂, Mg(BH₄)₂, Zn(BH₄)₂, Al(BH₄)₃, a polyborohydride, (CH₃)₃NBH₃, and NaCNBH₃.

30. The method of claim 26, wherein the second chamber comprises water.

31. The method of claim 26, wherein the third chamber comprises a liquid electrolyte which comprises at least one of an alkali metal hydroxide and an alkaline earth metal hydroxide.

32. The method of claim 31, wherein the liquid electrolyte comprises an aqueous solution of at least one of NaOH and KOH.

33. The method of claim 16, wherein the fuel/electrolyte module comprises flexible material chambers.

34. The method of claim 16, wherein the fuel/electrolyte module comprises a plurality of separate sealed chambers and a plurality of puncturing members, each puncturing member being capable of puncturing a sealing member when the chambers experience compressive forces.

35. The method of claim 16, wherein the system for transferring comprises opposing surfaces of said parts of the housing arrangement which, when moved towards each other, cause a volume reduction of chambers of the fuel/electrolyte module.

36. A method of activating a fuel cell system comprising a fuel cell and a fuel/electrolyte module arranged within a housing arrangement, the method comprising at least one of:
subjecting the housing arrangement to compression to cause at least a part of the contents of the fuel/electrolyte module to transfer from the fuel/electrolyte module to the fuel cell;
gripping and squeezing the housing arrangement to cause at least a part of the contents of the fuel/electrolyte module to transfer from the fuel/electrolyte module to the fuel cell; and
moving two portions of the housing arrangement relative to each other to cause at least a part of the contents of the fuel/electrolyte module to transfer from the fuel/electrolyte module to the fuel cell.

37. The method of claim 36, wherein the fuel cell system is at least one of a stand-alone unit, a modular unit, and a portable unit.
